(19) United States
(12) Patent Application Publication
(10) Pub. No.: US 2004/0225551 A1
(43) Pub. Date: Nov. 11, 2004

(54) System and methodology for organizational collaboration and administration

(76) Inventor: Stephen Hole, Falls Church, VA (US)

Correspondence Address: UNIVENSITY SOLUTIONS, c/o STEPHEN HOLE, 315 EAST 58th STREET, # 2A, NEW YORK, NY, 10022, US

(21) Appl. No.: 10/799,720

(22) Filed: Mar. 15, 2004

Related U.S. Application Data
(60) Provisional application No. 60/454,302, filed on Mar. 14, 2003.

(51) Int. Cl. G06F 17/60

(52) U.S. Cl. 705/9

(57) ABSTRACT

A system and a method for providing automated formal membership recruitment process for clubs, membership organizations, sororities, and fraternities. In a preferred embodiment, such functions are available in a networked environment and the time, expense and effort needed in performing these services are greatly reduced. The present invention can be utilized in club and/or organizational membership administration, communication, collaboration, and/or promotion with members of that organization regardless of duration and/or type.

### CROSS-REFERENCE TO RELATED APPLICATION

This application claims priority of U.S. Provisional Application No. 60/454,302 filed Mar. 14, 2003, the disclosure of which is incorporated fully herein.

### BACKGROUND

1. Field of the Invention

The present invention is directed to a system and a methodology for providing club and/or organizational membership administration, communication, collaboration, recruitment, and/or promotion between and among members of that organization. More particularly, the present invention is directed to performing such functions in a networked environment.

2. Background of the Invention

The first college Greek organizations—including both men's fraternities and women's sororities, which are jointly termed fraternities—were established on American college campuses over 100 years ago. Until sixty-some years ago, sororities' new member recruitment activities, or rush, remained unorganized. Recognizing a need for standard processes, the National Panhellenic Council (NPC), the umbrella organization of American sororities, stepped in. The NPC devised a process for matching potential members to sororities, to ensure equal and fair membership recruitment opportunities for all students and sororities involved.

This resulting process became known as the “Preferential Bidding System” (PBS). PBS outlines procedures for processing women's and sororities' membership preferences, and it defines interdependent roles for the college's Office of Greek Life, sorority members and “rushees” (herein after referred to as potential members and/or PM's), sorority alumnae, and sorority National Headquarters. Still in use today by all NPC-affiliated sororities on college campuses, PBS's value is proven.

The first Greek-letter sorority was founded in 1870. A sorority may be present on campuses throughout the United States, and each sorority location is called a chapter. In the literature of fraternities and sororities, “fraternity” is used to mean either the all-male or the all-female social organizations, while “sorority” refers to the all-female organizations. Many sororities have joined a national organization, the National Panhellenic Conference (NPC), which, as of 2004, consisted of twenty-six sorority members. On each campus, all NPC sorority chapters are members of a College Panhellenic Council, the local governing body that determines rushing regulations.

Brown (1920, p14) [Brown, James T., ed, Baird's Manual of American College Fraternities, 9^{th} Ed., New York: James T. Brown, 1920.] described the early competition for members:

“In the early days of the fraternities only seniors were admitted to membership, but the sharp rivalry for desirable men soon pushed the contest into the junior class, and so on down, until at some colleges it scarcely stops at the academy. The general rule is, however, that members shall be drawn from the four undergraduate classes . . . . As the colleges usually open about the middle of September, the campaign for freshmen is then commenced and lasts until Christmas, when each chapter has secured its most desirable candidates. Where there is great rivalry, however, initiations take place all year round.”

Earlier appointment dates were not the only evidence of competition:

“Membership in two fraternities has been a source of trouble and vexation. It is almost universally forbidden. When it occurs between two chapters of different fraternities located at the same college, and a student leaves one and joins the other, it is termed ‘lifting,’ and such disloyalty is usually followed by expulsion. All of the fraternities now forbid this, although many years ago it was not uncommon.” [Brown, 1920, pp15-16]

An early attempt to resolve these problems occurred in 1891, when the first meeting of women's college fraternities, in what was then called the Inter-sorority Conference, was called to discuss interfraternity cooperation. Although resolutions were passed decrying the practice of “lifting,” and calling for “the abolition of the practice of pledging and initiating preparatory students,” this had little effect. Similar sentiments were expressed in subsequent years, to equally little effect, and by 1928 the NPC was ready to turn to a centralized system of matching, and the first mention of the Preferential Bidding system appeared. Francis Shepardson (1930, p8) [Shepardson, Francis W., ed., Baird's Manual of American College Fraternities, 12^{th} Ed., Menasha, Wis.: Collegiate Press, 1930.] reviews the events leading up to this:

“The constant rivalry among chapters and the multiplication of fraternities have led in many cases to an indiscriminate scramble for members at the beginning of each year. Both fraternities and the colleges have perceived the danger of this sort of ‘rushing,’ as the contest for members is called, and are giving the subject thoughtful consideration. The deferred pledging of students until a fixed date and the deferred initiation of pledged members until they have completed a prescribed portion of their college course or secured a predetermined grade are both becoming common. Such procedure is in striking contrast with earlier custom in some of the larger Western and Southern colleges where, the preparatory schools being intimately connected with the colleges, ‘preps’ were not only pledged, but initiated before they entered the college proper, or with the reprehensible custom which prevails in some places, where pledge pins are given out to boys in the high school or even in the grammar grades.”

The Preferential Bidding System has since been incorporated into the recruiting activities of sororities. The activities of a sorority seeking new members is called “rush” and/or “formal membership recruitment”. There are two types of rush—formal rush and continuous open bidding. The NPC recommends “one formal rush period per year, held in the early fall, as close as possible to the start of the academic year, and conducted in as short a period of time as possible.”

Women participating in formal rush attend a sequence of parties designed to enable PM's and sororities to “narrow their choices gradually.” The first parties are “open houses” in which all sororities issue invitations to all PM's. In subsequent rounds, sororities issue invitations selectively. “Panhellenic strongly urges each sorority to re-invite only those PM's they are seriously considering for membership. This will enable both the PM and the sororities to know ‘how they stand’ early in the formal rush period.” In each round the number of sororities a PM can attend is reduced. A PM who receives more invitations than the number of parties permitted in a given round must decline, or “regret”, the excess invitations. The last round of invitational parties, the “preference parties”, usually permit a PM to attend only two or three parties. “Panhellenic strongly urges each sorority to invite only those PM's to the preference party to whom they will definitely issue a bid.”

After the last preference party, PM's indicate their preferences over sororities on a card which they sign. (A PM who lists only a single sorority is said to have suicided.) Sororities similarly submit a preference ordering of PM's. Once all preferences have been submitted, the PBS process matches PM's to sororities. Each sorority is eligible to be matched to up to quota (q) PM's during formal rush, where quota is “the number of PM's accepting at least one invitation to the first round of invitational parties, divided by the number of participating fraternities”.

Following the completion of the PBS algorithm there is one more step in the formal rush process, which officially exists in two slightly different forms (and which in practice seems to vary somewhat more from campus to campus). Under the “Quota-Only” procedure, any sorority which has been assigned some number p of PM's by the PBS algorithm with p<q is allowed to extend one additional set of at most q-p bids to unmatched PM's. Under the “Quota-Plus” procedure, any sorority which has not been assigned q new members under the PBS algorithm, or whose total membership m+p (including the p new members) is below the total allowable chapter size, T, (which is the same for all sororities on a given campus) is allowed to extend one additional set of at most max{q−p, T−(m+p)} bids to unmatched PM's. PM's who were unmatched by the PBS algorithm are free to accept at most one of the bids they receive, or to decline all such bids. The results are announced on “Pledge Day” or “Bid Day” marking the end of formal rush. A PM who enters formal rush by signing a preference card, but who subsequently declines to join a sorority to which she has been matched, is not permitted to join another sorority for one year.

Continuous open bidding begins immediately after the close of formal rush. During continuous open bidding, any sorority which has not received q (quota) new members, or which has received q new members but is nevertheless below the total allowable chapter size, is allowed to recruit additional members by simply extending them invitations to join. At this stage, sororities are not restricted to make a single set of bids, but may recruit continuously until their membership reaches T (or, in the case of sororities whose initial membership m was greater than T−q, until they have recruited q new members).

In its current day form, the PBS algorithm operates as follows. First, PM's submit a “preference card” listing the sororities they would be willing to join, in order of preference. Sororities then submit a “bid list” of PM's whom they would be willing to have as members. While a PM can join no more than one sorority, every sorority is able to extend at least quota invitations for new members through the formal rush process. Beyond the first quota names, sororities list PMs in order of preference. These preference lists are used by the PBS algorithm to assign PM's to sororities. The following instructions are from the manual “How To” for College Panhellenics.

Sorority Rushing Instructions: The Preferential-Bidding System Algorithm

Bid Lists

1. At a specified time, each fraternity files with the Panhellenic Executive a list of women it wishes to bid.

a. Lists are in duplicate; one copy is used in bid matching, the other is returned to the chapter when the bid matching is completed.

b. The fraternity bid list should be on paper ruled into three columns:

Left hand column—List in alphabetical order of fraternity's first choices up to the limit of quota.

Right hand column—List in order of preference the fraternity's additional choices which may number as many as the chapter wishes to submit.

Center column—Is left blank, as this is the column in which the matched bids are entered.

As a bid is matched, the PM's name is crossed off every fraternity's first or second list. Her name is entered in the center column of the fraternity list of the group to which she is being pledged.

2. Along with its bid lists, each fraternity brings to Panhellenic enough formal bids (in envelopes) for each woman to be pledged. These formal bids are to be addressed after bid matching is completed.

Procedure for Matching Bids

1. Persons matching bids include the Reader, the Tabulator, and one alumnae handling the bid list from her fraternity. Undergraduates are not to participate in bid matching.

2. Before bid matching begins, names of all PM's who chose not to sign a preference card should be crossed off all preference lists, and those lists adjusted to fill the space of these women.

3. Mechanics:

a. After alphabetizing the preference cards, the reader calls the PM's name and her first choice. If the fraternity of her first choice has given her a bid on its first bid list, it is a matched bid, and all others should cross her from their list. If the PM's name is not on the fraternity's first bid list, her preference card is temporarily laid aside. Names of PM's who list only one preference and are unmatched at the end of the first reading should be crossed off all other bid lists and their cards laid aside.

b. Each time a name is crossed off a fraternity's first bid list, if openings in the fraternity's pledge quota remain, a name from the fraternity's second bid list is added, in the listed order, to the bottom of the unmatched names remaining on the first list. The number of unmatched names on the adjusted first bid list and the number of those pledged must always equal quota (unless a chapter has run out of names to add from its second bid list.)

c. The cards laid aside in step “a” are read again according to the first choice of the PM. This process is repeated as long as there is any possibility of the PM receiving a bid from the fraternity of her first choice.

d. Those cards remaining are those of PM's whose names are on the second bid list of the fraternities of their first choice.

e. When it becomes apparent a PM' will not receive a bid from the fraternity of her first choice, a PM's second choice is then matched, if possible, in the above manner.

f. Any remaining cards are then read according to the PM's third choice and the same procedure followed.

g. The tabulator reads the results and all bid lists are reviewed for accuracy.

h. Unmatched bids—If a PM's preference card has failed to match for a bid, the Panhellenic Executive may contact the PM and ask if she will accept a bid from a fraternity not previously listed among her choices, if this other fraternity has her name on one of their bid lists. Any PM not bid by any of her preference choices is eligible at any future time for rushing and pledging by any fraternity.

Unfilled Quotas—If a fraternity has failed to fill its quota through this bid matching in formal rush, it may be contacted by the Panhellenic Executive to ask if the fraternity wishes to extend a bid to anyone not originally on its bid lists. [Mongell, Susan, Roth, Alvin, E., Sorority Rush as a Two-Sided Matching Mechanism, The American Economic Review, Volume 81, Issue 3, (June, 1991, 441-464.]

While the PBS algorithm and other fraternal recruiting customs have stood the test of time, there is without doubt, room for improvement. In addition to various drawbacks associated with the recruiting process itself, there are various deficiencies in terms of the tools available to foster, grow and implement Greek life on campus. The collegiate Greek community is large, decentralized, and inefficient with its current processes. Local, regional, and national headquarters and organizational support groups lack a shared information management and collaboration system. With operations national in scope and groups geographically dispersed, the lack of standard and shared management applications results in fragmented operations.

While the Preferential Bidding System (PBS) has aged well, its arduous execution leaves more to be desired. The registration, events planning, member-matching, and reporting functions produce a heavy manual workload. The data entry, analysis, and planning is additionally burdened by the required adherence to NPC's exacting timelines and information security standards. While the Greek community may have a large membership to assist in the execution of its recruitment functions, its lack of standard collaboration tools breeds inefficiency, including:

1) Paper form registration at a geographic location deters registrants and burdens the Office of Greek life with full responsibility for entering each student's information into the recruitment database.

2) Lack of centralized reporting delays the delivery of information as needed by various organizational levels to proceed with member-matching processes and accordingly plan subsequent recruitment events.

3) Lack of centralized communication tools, delays event notifications to members and timely collaborative communications among the organization.

4) High officer turnover (i.e. due to yearly graduation and new officer appointments) requires time to train those unrehearsed in the recruitment process.

It will also be recognized that the deficiencies inherent in the bid matching process used in the Greek system are, in large part, emblematic of more general problems associated with organizational collaboration and communication.

### SUMMARY OF THE INVENTION

It is therefore a primary object of the present invention to overcome the drawbacks described above as well as other related drawbacks existing in the prior art.

Accordingly, it is an object of the present invention to provide a system and a method for providing a centralized community-based system for clubs and organizations and membership-related services to input, manage, configure, store, analyze, compare, select, transfer, and report for members of such organizations.

It is another object of the present invention to provide a system and a method for providing a formal process by which women and men at colleges and universities join the social organizations called sororities and fraternities.

It is still another object of the present invention to provide a system and a method for providing a centralized community-based system for clubs and organizations and membership-related services, on and/or over the Internet, the World Wide Web, and/or any other communication network.

It is yet another object of the present invention to provide a system and a method for providing a centralized community-based system for clubs and organizations and membership-related services which provides links to various data which may be requested, required, and/or desired, by the respective parties involved in such organizations.

It is another object of the present invention to provide a system and a method for providing a centralized community-based system for clubs and organizations and membership-related services, which utilizes databases which can be linked to external information sources.

It is still another object of the present invention to provide a system and a method for providing a centralized community-based system for clubs and organizations and membership-related services, which facilitates the posting of data by authorized individuals of the application.

It is yet another object of the present invention to provide a system and a method for providing a centralized community-based system for clubs and organizations and membership-related service, which allows an individual to perform searches within the application.

It is still another object of the present invention to provide a system and a method for providing a centralized community-based system for clubs and organizations and membership-related service, which notifies an individual of which organizations have invited them back to the next round of events during the formal membership recruitment process.

It is another object of the present invention to provide a system and a method for providing a centralized community-based system for clubs and organizations and membership-related service, that utilizes data which is specific, generic, and/or general, to an individual, to a fraternity, sorority, membership organization, or institute of education.

It is another object of the present invention to provide a system and a method of providing a centralized community-based system for clubs and organizations and membership-related service, which utilizes electronic messages and/or e-mail messages which contain links to information and/or information sources which may be utilized in providing said information.

It is yet another object of the present invention to provide a system and a method for providing a centralized community-based system for clubs and organizations and membership-related service, which provides scheduling services and/or schedule management services for an individual, a club, a membership organization, or administrative staff.

It is yet another object of the present invention to provide a system and a method for providing job searching services, recruitment services, and/or recruitment-related services, which can be utilized by an individual, a club, a membership organization, administrative staff, and/or a party acting on behalf of same.

It is another object of the present invention to provide a system and a method for providing a centralized community-based system for clubs and organizations and membership-related service, which prevents access to certain data by certain parties.

It is still another object of the present invention to provide a system and a method for providing a centralized community-based system for clubs and organizations and membership-related service, which can be programmed to be self-activating and/or be activated automatically.

It is yet another object of the present invention to provide a system and a method for providing a centralized community-based system for clubs and organizations and membership-related service, which generates electronic messages, e-mail messages, telephone calls, pager calls, pager messages, and/or other communication messages, automatically.

It is another object of the present invention to provide a system and a method for providing a centralized community-based system for clubs and organizations and membership-related service, which utilizes intelligent agents, software agents, and/or mobile agents, for providing various services for, and/or for taking action on behalf of, a respective party.

It is still another object of the present invention to provide a system and a method for providing a centralized community-based system for clubs and organizations and membership-related service, which provides links and/or hyperlinks to information, products and/or services related thereto.

It is yet another object of the present invention to provide a system and a method for providing a centralized community-based system for clubs and organizations and membership-related service, which provides automatic notification of, and/or announcements of, and/or the availability of goods and/or service providers, to respective parties.

It is another object of the present invention to provide a system and a method for providing a centralized community-based system for clubs and organizations and membership-related service, which monitors, records, and/or provides notification of, any communications or transactions which take place and/or which may transpire between respective parties.

It is still another object of the present invention to provide a system and a method for providing a centralized community-based system for clubs and organizations and membership-related service, which provides for the generation of and/or the distribution of electronic catalogs and/or electronic coupons related to personal, promotional, and/or formal membership recruitment activities.

It is yet another object of the present invention to provide a system and a method for providing a centralized community-based system for clubs and organizations and membership-related service, which provides notification of formal membership recruitment-related and/or membership organization-related events and/or occurrences.

It is another object of the present invention to provide a system and a method for providing a centralized community-based system for clubs and organizations and membership-related service, which monitors, records and/or keeps track of, formal membership recruitment activities and/or membership organization activities of, and for, any of the respective parties.

It is still another object of the present invention to provide a system and a method for providing a centralized community-based system for clubs and organizations and membership-related service, which provides for the storage and/or the utilization of data with various levels of confidentiality and/or specificity.

It is another object of the present invention to provide a system and a method for providing a centralized community-based system for clubs and organizations and membership-related service, which provides enhanced confidentiality during a membership recruitment process, and/or related activities and/or interactions.

It is still another object of the present invention to provide a system and a method for providing a centralized community-based system for clubs and organizations and membership-related service, which monitors and/or records communications, interactions, and/or dealings, between parties.

It is yet another object of the present invention to provide a system and a method for providing a centralized community-based system for clubs and organizations and membership-related service, which provides statistical information pertaining to membership organizations, formal membership recruitment activities, survey and/or polling, and/or related activities.

It is still another object of the present invention to provide a system and a method for providing a centralized community-based system for clubs and organizations and membership-related service, which can administer a financial account for, and/or on behalf of a party, and which can effect a payment from one party to another, and/or receive a payment for, and/or on behalf of, a party.

It is yet another object of the present invention to provide a system and a method for providing a centralized community-based system for clubs and organizations and membership-related service, for schools, colleges, universities, and/or any organizations of any kind.

Other objects and advantages of the present invention will be apparent to those skilled in the art upon a review of this disclosure taken in conjunction with the figures which follow.

The process of recruiting members for any new club, membership organization, and/or recruitment activities are far too widespread and are far too important to be limited by the above-described limitations and/or constraints. Administrator's, potential new members, and existing club and/or membership organizations, would be better served by a system which overcomes the shortcomings of the prior art.

The apparatus and method of the present invention overcomes the shortcomings of the prior art and provides club and/or organizational membership administration, communication, collaboration, and promotion with members of that organization regardless of duration and/or type, including a memory device for storing information regarding such data, a processing device for processing information regarding the automated formal membership recruitment process for clubs, membership organizations, sororities, and fraternities. The present invention utilizes the technologies and advances in information technology and in communication technology in order to provide these services in a network environment.

The apparatus and method of the present invention can be utilized in a network environment in order to effectuate any of the services described herein on, or over, any communication network. The apparatus can include a central processing computer or server computer, at least one or more individual computers and at least one or more company administrative computers. Each of the herein-described computers may communicate with any and all of the computers which are utilized in conjunction with the apparatus of the present invention. The present invention may be utilized in any communication network such as the Internet, the World Wide Web, a telecommunications network, and/or any other communication network described herein and/or otherwise.

Each of the central processing computer(s), the individual computers, and/or the company administrative computers can include any and/or all components, peripherals, hardware, and/or software, for facilitating the use thereof in a manner consistent with the present invention as described herein. The central processing computer may also include, and/or be linked to, one or more databases for storing any and/or all of the data which may be utilized in conjunction with the present invention.

The present invention provides administration, communication, collaboration, and/or promotion with members of that organization regardless of duration and/or type, while preserving confidentiality among, between the parties, and/or between the parties and third parties, and may further provide for varying layers of confidentiality for the parties involved. The present invention can also provide enhanced information services for the parties utilizing same, including but not limited to, links, hyperlinks, and/or other pointing and/or linking devices for linking a user to additional and/or supplemental information concerning any of the individuals, clubs, membership organizations, sororities, and/or fraternities, involved in a recruiting new members to their respective organizations.

The data utilized in conjunction with the present invention can also be utilized by the various individuals, educational institutions, clubs, groups, third party intermediaries, and/or the operator and/or the administrator of the apparatus, and can be uploaded to, downloaded from, and/or be stored or be resident on any of the central processing computer(s), the individual computer(s), and/or the employee computer(s).

Any and all of the communications between the parties may be effected via electronic message transmission, e-mail, electronic forms submission, a telephone call, telephone messaging, facsimile messaging, pager and/or beeper messaging, physical mailing, and/or via any other appropriate method, means and/or mechanism.

The apparatus and method of the present invention can also be utilized for performing and for facilitating the provision of community interaction, formal membership recruitment services for schools, colleges, universities, and any organizations of any kind. The apparatus of the present invention can also be configured to be self-activating and/or activated automatically. The apparatus of the present invention can also be configured to generate and transmit any of the e-mails, electronic message transmissions, electronic notification transmissions, and any of the communications, described herein between any of the parties utilizing the present invention.

The present invention can be utilized in conjunction with intelligent agents, software agents and/or mobile agents, in order to provide for these respective agents to act for, or on behalf of, a respective party. The present invention can also be utilized in order to generate electronic catalogs and/or electronic coupons for advertising and for publicizing the availability of products and services to members of the application. The present invention, can also store individual and/or group data with various and varying levels of specificity and/or confidentiality.

The apparatus and method of the present invention can be utilized as an electronic and/or network-based recruiting apparatus and clearinghouse for sororities and fraternities that reside on a college campus. The present invention can be utilized in order to reduce recruitment costs and for colleges and the expenses to the individuals desiring to join such organizations. The present invention provides a system and a method for eliminating the traditionally manual process of sorority and fraternity formal membership recruitment for any of the individuals, staff, or groups described herein. The present invention can utilize electronic commerce technologies and security methods, techniques and technologies.

### BRIEF DESCRIPTION OF THE DRAWINGS

FIG. 1 illustrates the system of the present invention, in block diagram form;

FIG. 2 illustrates the central processing computer of the system of FIG. 1, in block diagram form;

FIG. 3 illustrates the individual computer of the system of FIG. 1, in block diagram form;

FIG. 4 illustrates the employee computer of the system of FIG. 1, in block diagram form;

FIGS. 5A, 5B and 5C are flowcharts illustrating a preferred embodiment of the application of the system of the present invention in which preference and bid-matching is performed;

FIG. 6 is an exemplary screen shot associated with a user interface of a preference and bid-matching system which operates according to the teachings of the present invention in a preferred embodiment thereof;

FIG. 7 is another exemplary screen shot associated with a user interface of a preference and bid-matching system which operates according to the teachings of the present invention in a preferred embodiment thereof;

FIG. 8 is yet another exemplary screen shot associated with a user interface of a preference and bid-matching system which operates according to the teachings of the present invention in a preferred embodiment thereof;

FIG. 9 is yet another exemplary screen shot associated with a user interface of a preference and bid-matching system which operates according to the teachings of the present invention in a preferred embodiment thereof;

FIG. 10 is yet another exemplary screen shot associated with a user interface of a preference and bid-matching system which operates according to the teachings of the present invention in a preferred embodiment thereof;

FIG. 11 is yet another exemplary screen shot associated with a user interface of a preference and bid-matching system which operates according to the teachings of the present invention in a preferred embodiment thereof;

FIG. 12 is yet another exemplary screen shot associated with a user interface of a preference and bid-matching system which operates according to the teachings of the present invention in a preferred embodiment thereof;

### DETAILED DESCRIPTION OF THE INVENTION

The present invention is directed to a system and method for providing club and/or organizational membership administration, communication, collaboration, and/or promotion with members of that organization regardless of duration and/or type, including a database for storing information regarding such information. A processing device for processing information regarding collaboration and communication activities is also included. The present invention has a great many applications and may be used in a broad set of environments. In one preferred embodiment of the present invention, the system and methodologies are used in connection with the recruitment process associated with fraternities and/or sororities. As will be understood by one of skill in the art, this application is merely exemplary, and the invention, system and methodologies are not limited thereto. While the following description is specific in application, it will be readily understood that the teachings presented herein may be readily applied to various other applications and still fall within the scope and spirit of the present invention.

In the preferred embodiment described herein, the system operates to effect the recruitment process for clubs, membership organizations, sororities, and fraternities, in a networked and/or stand alone environment, wherein the processing device utilizes information regarding at least one of a member profile, an individual, a club, or an organization, stored in the database, and further the processing device periodically generates reports or messages which are responsive to the preferences of both the individual and club. The present invention may also comprise a transmitter for transmitting the message to a communication device associated with an individual, device or entity in real-time.

For purposes of the exemplary embodiment described herein, the terms “member”, “user”, “potential member”, “potential new member”, “prospective member”, “pledge”, “rushee”, “recruit”, “new recruit”, etc., as used herein, refer to any individual, person, group, agency, and/or any other entity, that is either currently a member of a club or organization or is seeking to become a member of a club or organization for himself, herself, itself, and/or for another. The terms “employee”, “super user”, “company”, “business”, etc., as used herein, refer to any company employee, hired to provide assistance in using the said apparatus and methods. The terms “administrator”, “admin.”, “office of greek life coordinator”, “office of student activities”, “club administrator”, “club admin.” etc., refer to any individual, person, and/or entity, who or which acts as an intermediary for, on behalf of, any party or parties described herein, in order to initiate and/or to effectuate the administrative functions for a particular college and/or university or any membership groups or any searches or activities which result, and/or which proceed, therefrom.

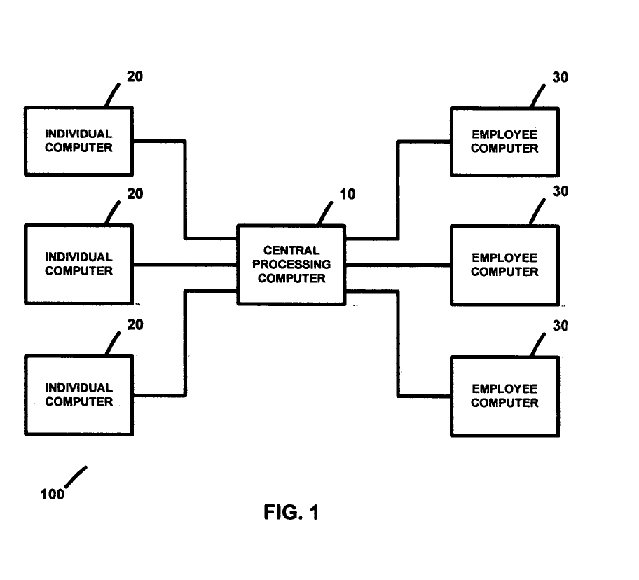

FIG. 1 illustrates a preferred embodiment of the apparatus of the present invention which is designated generally by the reference numeral 100. In FIG. 1, the apparatus 100 includes a central processing computer or server computer 10. Central processing computer 10 provides control over the apparatus 100 and provides services for the various computers associated with the various individuals: “member”, “user”, “potential member”, “potential new member”, “prospective member”, “pledge”, “rushee”, “recruit”, “new recruit”, employee”, “super user”, “company”, “business”, “administrator”, “admin.”, “office of greek life coordinator”, “office of student activities”, “club administrator”, “club admin”, etc., who or which utilize the apparatus 100 of the present invention.

Central processing computer 10, in the preferred embodiment, can be any suitable computer, network computer, or computer system, for providing service for the various computers associated with the individuals, “member”, “user”, “potential member”, “potential new member”, “prospective member”, “pledge”, “rushee”, “recruit”, “new recruit”, employee”, “super user”, “company”, “business”, “administrator”, “admin.”, “office of greek life coordinator”, “office of student activities”, “club administrator”, “club admin”, etc., who or which utilize the present invention.

In the preferred embodiment, any number of central processing computers 10 may be utilized in order to provide the servicing functions described herein. Central processing computer(s) 10 may be linked to other central processing computers or may be stand alone devices. A given central processing computer 10 may service a particular geographic area or certain individuals “member”, “user”, “potential member”, “potential new member”, “prospective member”, “pledge”, “rushee”, “recruit”, “new recruit”, employee”, “super user”, “company”, “business”, “administrator”, “admin.”, “office of greek life coordinator”, “office of student activities”, “club administrator”, “club admin”, etc., and/or groups thereof. Central processing computer 10 may also be dedicated to service any one or group of the above described individuals and/or entities.

System 100, in the preferred embodiment, also includes one or more individual computers 20. Each individual computer 20 may be a personal computer or other communication device suitable for allowing the individual to interact with central processing computer(s) 10. Each individual computer 20 can be utilized to transmit information to central processing computer 10 and to receive information from central processing computer 10 via the communication network.

Individual computer 20 can be a personal computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and/or a watch. In the present invention, any number of individual computers 20 may be utilized. In the present invention, each individual or entity utilizing the present invention may have one or more individual computers 20 associated therewith.

System 100, in a preferred embodiment, also includes one or more employee computers 30. Each employee computer 30 may be a personal computer or other communication device suitable for allowing the employee to interact with central processing computer(s) 10. Each employee computer 30 can be utilized to transmit information to central processing computer 10 and to receive information from central processing computer 10 via the communication network.

Employee computer 30 can be a personal computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and/or a watch. In the preferred embodiment, any number of employee computers 30 may be utilized. In the present invention, each employee utilizing the present invention may have one or more employee computers 30 associated therewith.

Each individual computer(s) 20 and each employee computer(s) 30 described herein can transmit information to each central processing computer 10 as well as receive information from each central processing computer 10. In addition, each individual computer 20 can also transmit information to any employee computer 30 as well as receive information from any employee computer 30. In a similar-manner, each employee computer 30 can transmit information to any individual computer 20 as well as receive information from any individual computer 20.

Central processing computer(s) 10, individual computer(s) 20, and/or employee computer(s) 30 can communicate with one another, and/or be linked to one another, over a communication network and/or a wireless communication network. In the preferred embodiment, the present invention is utilized on, and/or over, the Internet and/or the World Wide Web. The present invention, in the preferred embodiment, can also utilize wireless Internet and/or World Wide Web services, equipment and/or devices. Central processing computer(s) 10, in the preferred embodiment, may have a web site or web sites associated therewith.

Although the Internet and/or the World Wide Web is the preferred communication system and/or medium utilized, the present invention, in all of the embodiments described herein, can also be utilized with any appropriate communication systems including, but not limited to, network communication systems, telephone communication systems, cellular communication systems, digital communication systems, personal communication systems, personal communication services (PCS) systems, satellite communication systems, broad band communication systems, low earth orbiting (LEO) satellite systems, and/or public switched telephone networks or systems.

In a preferred embodiment, each central processing computer(s) 10, individual computer(s) 20, and employee computer(s) 30, can transmit data using TCP/IP, as well as any other Internet and/or World Wide Web, protocols.

Individual computer 20, in a preferred embodiment, can be linked directly or indirectly with a central processing computer 10. Employee computer 30, in the preferred embodiment, can also be linked directly or indirectly with a central processing computer 20. In any of the preferred embodiments described herein, any individual computer(s) 20 and any employee computer(s) 30 can be linked directly or indirectly with one another so as to facilitate a direct or indirect bi-directional communication between an individual computer(s) 20 and an employee computer(s) 30.

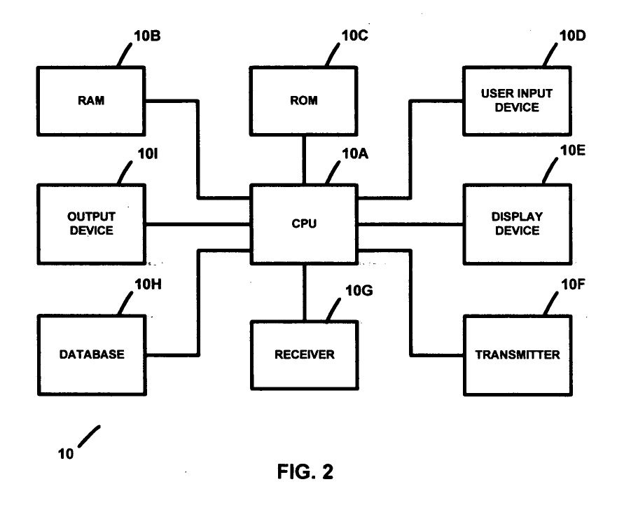

FIG. 2 illustrates central processing computer 10, in block diagram form. Central processing computer 10, in the preferred embodiment, is a network computer or computer system which is utilized as a central processing computer such as an Internet server computer and/or a web site server computer. In the preferred embodiment, central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

Central processing computer 10 also includes a random access memory device(s) 10B (RAM) and a read only memory device(s) 10C (ROM), each of which is connected to the CPU 10A, a user input device 10D, for entering data and/or commands into central processing computer 10, which includes any one or more of a keyboard, a scanner, an optical mark reader, an optical mark scanner, a user pointing device, such as, for example, a mouse, a touch pad, and/or an audio input device and/or a video input device, etc., if desired, which input device(s) are also connected to the CPU 10A. Central processing computer 10 also includes a display device 10E for displaying data to a user or operator.

Central processing computer 10 also includes a transmitter(s) 10F, for transmitting signals and/or data to any one or more individual computer(s) 20 and employee computer(s) 30 which may be utilized in conjunction with the present invention. Central processing computer 10 also includes a receiver 10G, for receiving signals and/or data from any one or more individual computer(s) 20 and/or employee computer(s) 30.

Central processing computer 10 also includes at least one database 10H which contains data pertaining to the individuals, employees, members, users, administrators, and/or other persons or entities, who or which utilize the present invention. Database 10H also contains data pertaining to the members and/or users who or which utilize the present invention to recruit individuals, in order to satisfy their needs and/or requirements.

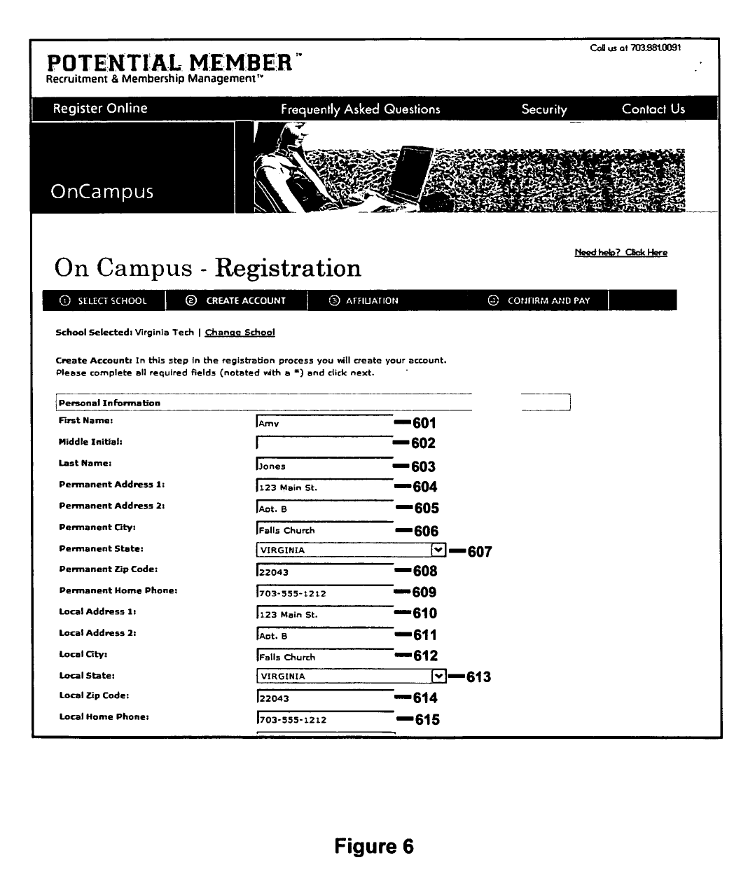

As seen in FIG. 6, individual data, which can be stored in database 10H, can include, but not be limited to, the individual's first name (field 601), middle initial (field 602), last name (field 603), permanent street address 1 (field 604), permanent street address 2 (field 605), permanent city (field 606), permanent state (field 607), permanent zip code (field 608), permanent home phone with area code (field 609), email address, password, confirm password, security question, answer to security question, middle initial, local street address 1 (field 610), local street address 2 (field 611), local city (field 612), local state (field 613), local zip code (field 614), local home phone with area code (field 615), social security number, school ID number, date of birth, sex, parents or guardian, high school name, high school city, high school state, high school zip code, high school phone number, date of graduation, high school GPA un-weighted, SAT Scores, ACT Scores, What year are your at [insert college/university name]?, [insert college/university name] GPA, credit hours earned, have you attended community college or another university?, If so, what is the institution name?, community college/other university GPA, community college/other university credit hours earned, name to be printed on nametag, school transcripts, links to registrar's offices, links to databases at respective school(s), links to a transcript database and/or electronic storage facility, medium, and/or device, which stores transcripts, other scholastic information, and/or educational information about an individual(s), work samples, reference letters, recommendation letters, pictures, video clips, other relevant information, and/or pertinent information. In this manner, the present invention facilitates more efficient access to data pertaining to an individual(s). In order to preserve confidentiality of each member and their user profile, each member's email address may be used as their login name, and is a unique identifier of the user.

Each and every field of data can be represented by a corresponding generic term or terms so as to keep the true information masked for a desired time period or during a certain period of processing. Any of the data may have hyperlinks associated therewith for directing an authorized party to a separate and/or a different data source. The information source may be external from central processing computer 10.

Database 10H can also contain data restricting access to any of the data stored in database 10H. For example, an authorized individual, administrator, super user, or club administrator, may, at any time, restrict access by any party, to any of their respective data. Additionally, an administrator may prevent all sororities or fraternities from accessing any potential member, potential new member, or rushee, or his or her related data during the formal membership recruitment, rush, or recruitment process, thereby maintaining the confidentiality of such personal contact data during this period to avoid unauthorized recruitment (sometimes referred as ‘dirty rushing’) practices. Similarly, any party may restrict the availability of any of its data from any other party or parties.

In the cases of members, users, potential members, employees, super users, administrators, clubs, organizations, etc., database 10H can contain information regarding the personal schedules and/or membership organization(s) calendars for any of these individuals, members, users, potential members, employees, super users, administrators, clubs, organizations, and/or entities. In this regard, each individual, member, user, potential member, employee, super user, administrator, club, organization, and/or entity in this category may store and have maintained by system 100, a personal schedule, a membership organization public and/or private calendar which can provide information regarding the social and/or administrative schedule of said individuals and groups.

Data contained in database 10H can also include information concerning events, occurrences, appointments, etc., of a member, user, potential member, employee, super user, administrator, club, organization, etc., and can be designated either public or private. Private events, occurrences, appointments, etc., are only visible on the personal calendar of the member, user, potential member, employee, super user, administrator, club, organization, etc. Public events are visible on the personal calendars of all members, users, potential members, employees, super users, administrators, clubs, organizations, etc., that were invited and/or asked to attend a specific event.

Authorization is required based on the role or permission access of the member, user, potential member, employee, super user, administrator, club, organization, etc. Each member, user, potential member, employee, super user, administrator, club, organization, etc., may only distribute information concerning events, occurrences, appointments, etc. if they have the authorized permission to perform such activities.

Database 10H may also contain information regarding which members, users, potential members, employees, super users, administrators, clubs, organizations, etc., have been invited to various events. If a said member was invited to such an event, the event will be visible in the ‘Undecided Events’ block of their personal calendar. The said member will then have the option of either choosing ‘yes’, ‘no’, or ‘maybe’ on attending the event. If the said member selects ‘yes’ to attend the event, the event is automatically transferred from the ‘Undecided Events’ and moved to the said members calendar. If the said member selects ‘no’, the event is deleted and removed from the ‘Undecided Events’ block. If the said member selects ‘maybe’, the event will remain in the ‘Undecided Events’ block until the said member selects either ‘yes’ or ‘no’ to the event. The event will remain in the ‘Undecided Events’ block until the date of the said event has expired.

Database 10H may also contain any other information which may be relevant, pertinent or useful for facilitating the operation of the apparatus and method of the present invention as described herein and/or as related thereto. Database 10H, in a preferred embodiment, is a database which may include individual databases or collections of databases, with each database being designated to store any and all of the data described herein.

Database 10H may also contain data concerning past events, selections (for formal membership recruitment), and/or transactions with such data being stored after each event, selection, and/or transaction which occurs via the system and method of the present invention. Any and all data can be stored regarding transactions which occur via the present invention as well as those transactions which occur independently of the present invention. The data can then be compiled and processed using statistical calculations in order to update the stored historical placement and/or transaction data with such data being made available to users of system 100.

Database 10H may also contain data regarding the latest developments as stipulated by the National Panhellenic Council (hereinafter “NPC”), the National Interfraternity Conference (hereinafter “NIC”), and/or resolutions, laws, practices, and procedures of any fraternity, sorority, or membership organization. The data which is stored in database 10H, or in the collection of databases, can be linked via relational database techniques to the respective client, member, university, college, club, etc., computers 30 and/or individual computers 20 or via any appropriate database management techniques. The data, in a preferred embodiment, can be updated via inputs from the respective individual computers 20, and/or client, member, university, college, club, etc., computers 30, and/or from any other information source, at any time. Information updates can also be provided from other information sources via the communication network.

Database 10H, or collection of databases, may be updated by each of the respective individuals, employees, or by an administrator and/or operator of central processing computer 10, by any other third party, in real-time, and/or via dynamically linked database management techniques. The data stored in database 10H can also be updated by external sources. Database 10H will contain any and all information deemed necessary and/or desirable for providing all of the processing and/or services and/or functions described herein.

Database 10H can also contain any information needed for corresponding with any of the members, users, potential members, employees, super users, administrators, clubs, organizations, etc., described herein, such as their respective addresses, telephone numbers, e-mail addresses, pager number, and/or any other information for facilitating a communication with any of these respective parties. Database 10H can also include personal and/or professional data, and/or any other data needed for performing any of the herein-described methods and features of the present invention.

With reference once again to FIG. 2, central processing computer 10 may also include an output device 101 such as a printer, a modem, a fax/modem, or other output device, for providing data to the operator or user of central processing computer 10 or to a third party or third party entity.

In a preferred embodiment, each individual computer(s) 20 and employee computer(s) 30 may include the same, similar, or analogous, components and/or peripheral devices as described herein for central processing computer 10. In this manner, any individual computer(s) 20 or employee computer(s) 30, may be the same as, or be similar to, central processing computer 10. In this regard, and depending upon the application and/or individual and/or employee requirements, each individual computer(s) 20 and/or each of the employee computer(s) 30 can have the same or similar components as central processing computer 10.

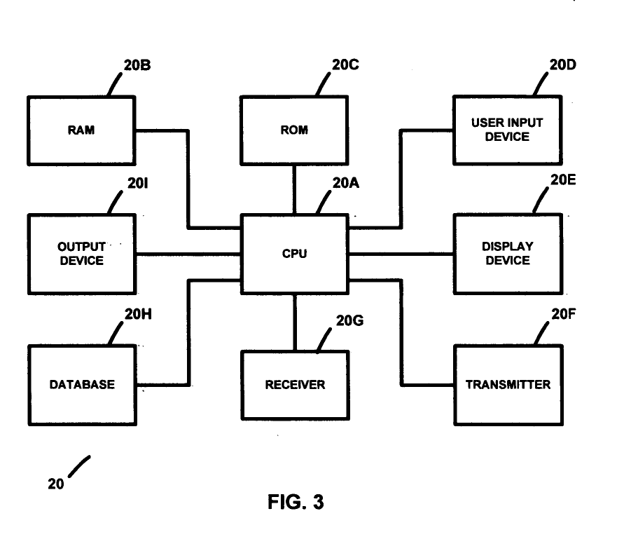

FIG. 3 illustrates individual computer 20, in block diagram form. Individual computer 20, in the preferred embodiment, is a network computer or computer system which is utilized to access and/or to communicate with central processing computer 10. In the preferred embodiment, individual computer 20 includes a central processing unit or CPU 20A, which in the preferred embodiment, is a microprocessor. CPU 20A may also be a microcomputer, a minicomputer, a macrocomputer, and/or a mainframe computer, depending upon the application.

Individual computer 20 also includes a random access memory device(s) 20B (RAM) and a read only memory device(s) 20C (ROM), each of which is connected to CPU 20A, a user input device 20D, for entering data and/or commands into individual computer 20, which includes any one or more of a keyboard, a scanner, a user pointing device, such as, for example, a mouse, a touch pad, and/or an audio input device and/or a video input device, etc., if desired, which input device(s) are also connected to CPU 20A. Individual computer 20 also includes a display device 20E for displaying data to a user or operator.

Individual computer 20 also includes a transmitter(s) 20F, for transmitting signals and/or data to any one or more of central processing computer(s) 10 and to employee computer(s) 30. Individual computer 20 also includes a receiver 20G, for receiving signals and/or data from any one or more of central processing computer(s) 10 and/or employee computer(s) 30.

Individual computer 20 also includes database(s) 20H which can contain any and/or all of the data described herein with regards to database 10H of central processing computer 10. Database 20H can also contain data personal to an individual or group of individuals, as well as data concerning the schedule(s) and/or calendar(s) for the individual and/or group of individuals for which individual computer(s) 20 is/are associated.

With reference once again to FIG. 3, individual computer 20 also includes an output device 20I such as a printer, a modem, a fax/modem, or other output device, for providing data to the operator or user of individual computer 20 or to a third party or third party entity.

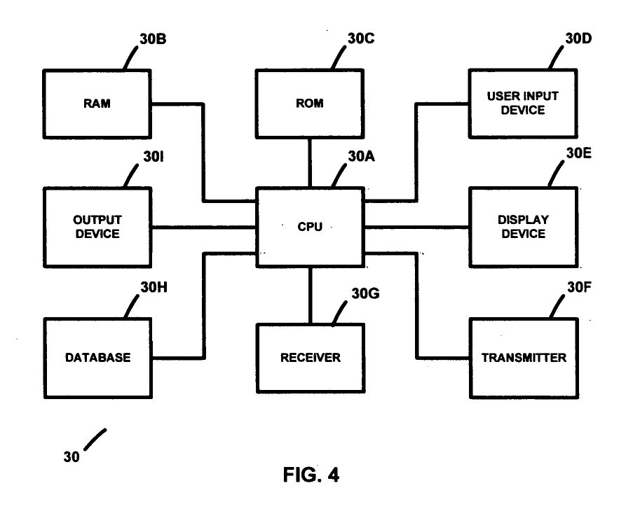

FIG. 4 illustrates employee computer 30, in block diagram form. Employee computer 30, in the preferred embodiment, is a computer or computer system which is utilized to access and/or to communicate with central processing computer 10. In the preferred embodiment, employee computer 30 includes a central processing unit or CPU 30A, which in the preferred embodiment, is a microprocessor. CPU 30A may also be a microcomputer, a minicomputer, a macro-computer, and/or a mainframe computer, depending upon the application.

Employee computer 30 also includes a random access memory device(s) 30B (RAM) and a read only memory device(s) 30C (ROM), each of which is connected to the CPU 30A, a user input device 30D, for entering data and/or commands into employee computer 30, which includes any one or more of a keyboard, a scanner, an optical mark reader (OMR), an optical mark scanner (OCR), a user pointing device, such as, for example, a mouse, a touch pad, and/or an audio input device and/or a video input device, etc., if desired, which input device(s) are also connected to CPU 30A. Employee computer 30 also includes a display device 30E for displaying data to a user or operator.

Employee computer 30 also includes a transmitter(s) 30F, for transmitting signals and/or data to any one or more of central processing computer(s) 10 and individual computer(s) 20. Employee computer 30 also includes a receiver 30G, for receiving signals and/or data from any one or more of central processing computer(s) 10 and/or individual computer(s) 20.

Employee computer 30 also includes at least one database 30H which can contain any and/or all of the data described herein with regards to database 10H of central processing computer 10. Database 30H can also contain data concerning a particular employee, as well as data concerning the work schedule(s), work calendar(s), or groups thereof, for which the employee computer 30 is associated.

With reference once again to FIG. 4, employee computer 30 also includes an output device 30I such as a printer, a modem, a fax/modem, or other output device, for providing data to the operator or user of individual computer 20 or to a third party or third party entity. Databases 20H and 30H of individual computer(s) 20 and employee computer(s) 30, respectively, can contain any and all of the data which is stored and contained in database 10H.

Database 10H, or collection of databases which form database 10H, as well as any database 20H and/or 30H, and/or any other database(s) described herein, can be implemented by utilizing database software and/or spreadsheet software, such as, for example database software by Oracle.RTM., Microsoft.RTM., Access.RTM., Microsoft.RTM., Excel.RTM., or any other suitable database or spreadsheet software programs and/or systems. The data can be provided by the various members, users, potential members, employees, super users, clubs, organizations, third party intermediaries, the operator, and/or the administrator of apparatus 100, and can be uploaded to, downloaded from, and/or be stored and/or be resident on any of central processing computer(s) 10, individual computer(s) 20, and/or employee computer(s) 30.

In a preferred embodiment, wherein system 100 is utilized over the Internet and/or the World Wide Web, hyperlinks, other data links, linking methods, and/or devices, can be utilized in order to provide an additional mechanism by which any individual computers 20 and/or any of employee computers 30, can access and/or communicate with any other individual computer 20, employee computer 30 as well as central processing computer. Any and/or all of central processing computer 10, the individuals computers 20, and/or employee computers 30, describe herein, can also be linked to, can access, and/or communicate with, any external computer, computer system, and/or information source (not shown), including, but not limited to, school registrar office computers, national fraternity headquarter computers, national sorority headquarter computers, national clubs and/or organizations computers, in order to access and/or obtain information therefrom. The data which is stored in database 10H, as well as stored in any of databases 20H and/or 30H, can be linked via any suitable data linking techniques such as, for example, dynamically linked lists (DLLs), linked lists, and object links embedded (OLE's).

In any and all of the embodiments described herein, each of individual computers 20, central processing computer(s) 10 and employee computers 30 can communicate with one another via electronic submissions, electronic form submissions and/or transmissions, e-mail transmissions, facsimile transmissions, telephone messages, telephone calls, physical mail delivery, and/or via any other suitable communication technique, medium, or method. Data regarding the above-described clubs, membership organizations, recruitment preferences, individuals, etc., can be stored in database 10H of central processing computer 10. The data can also be stored in database 20H of any individual computer 20 and/or in database 30H of any employee computer 30.

The apparatus and method of the present invention can be utilized in many alternative embodiments to provide automated formal membership recruitment process for clubs, membership organizations, sororities, and fraternities, in a network or stand alone environment.

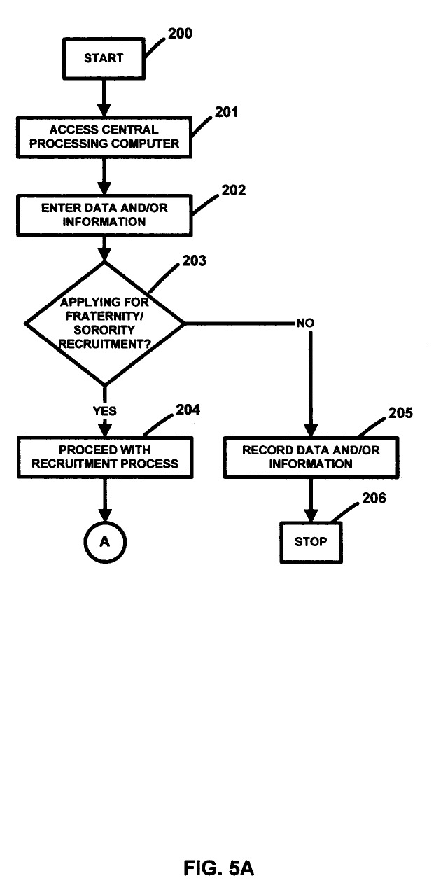

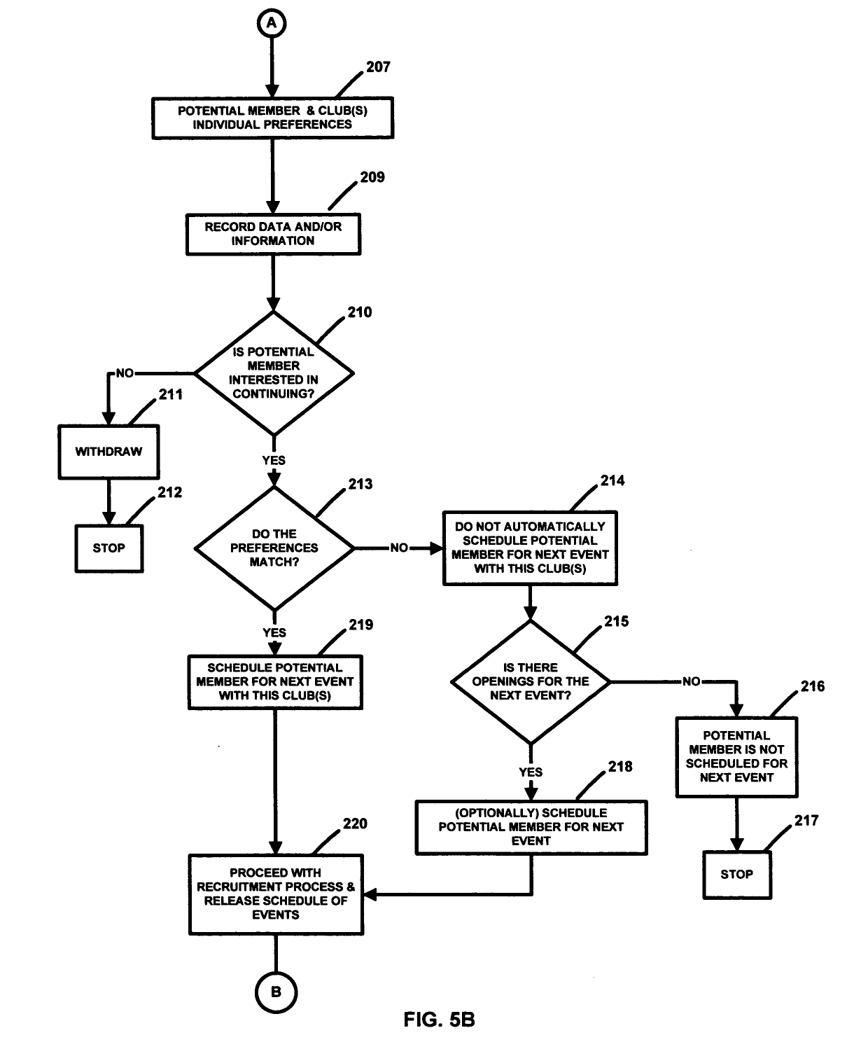

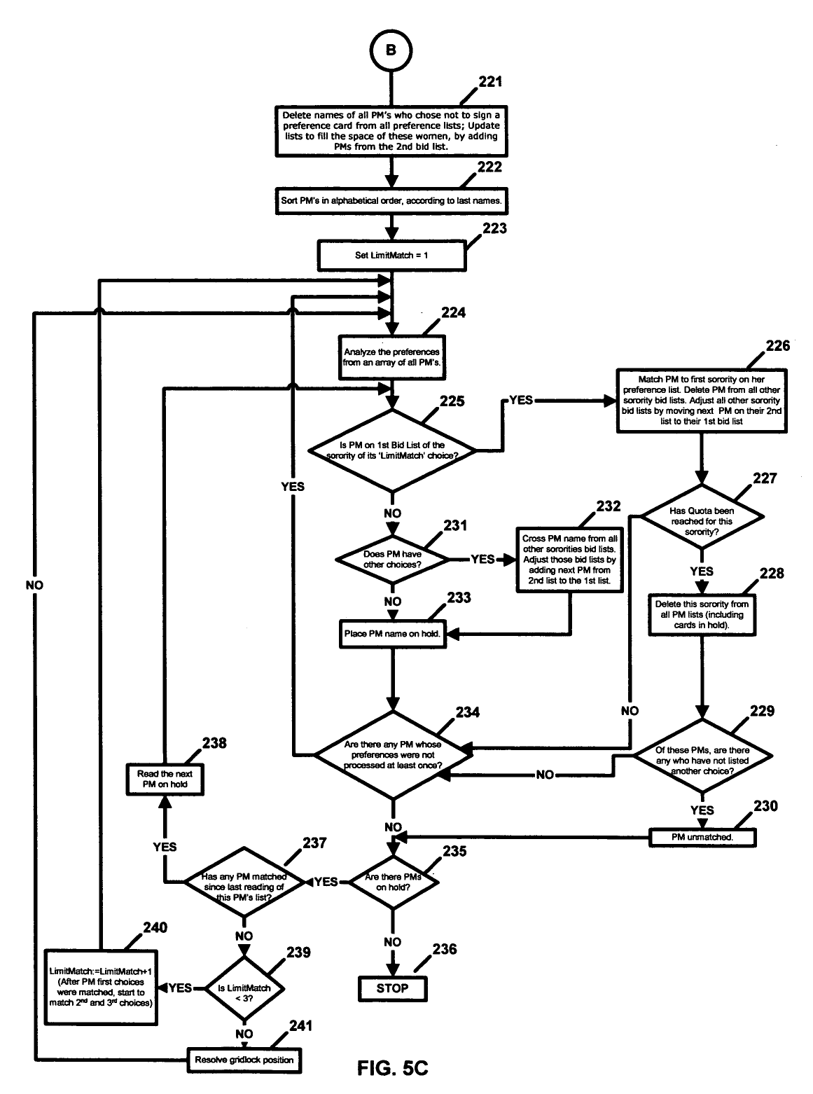

FIGS. 5A to 5C illustrate the operation of system 100 of FIG. 1 in a preferred embodiment wherein bid matching for greek organizations is performed. Specifically, FIGS. 5A to 5C illustrate a method for performing automated administration, recruitment, promotion, management, collaboration, and/or communication for club membership organizations, sororities, and/or fraternities. (hereinafter referred to as a “club” or “clubs”).

The operation of system 100 in a preferred embodiment thereof, commences at step 200. At step 201, the individual accesses central processing computer 10 via individual computer 30. The individual may, at step 202, enter data regarding his or her personal information, educational information, legacy information, pay applicable fees, and/or any other data pertinent to the club that they are registering for. Step 202 may be dispensed with if this information has been entered by the individual previously. The data can be entered specifically and/or generically. If entered specifically, the individual can also enter generic data to preserve confidentiality, if desired.

Data may also be entered into central processing computer 10 by uploading and/or downloading, whichever the case may be, a personal profile and/or any other pertinent data. Data may also be obtained via a questionnaire which may be provided and/or answered on-line. Any and/or all of such data may be stored in database 10H. Central processing computer 10 can also process the specific data in order to convert and/or separately store same as generic data. Any and all data stored at step 202, and/or previously, can be stored in database 10H of central processing computer 10 and/or in databases 20H and/or 30H, respectively, individual computer 20 and/or employee computer 30, as appropriate.

The data stored at step 202 is stored in database 10H for later use or reference by any individual, employee, and/or operator or administrator of system 100. Some or all of the data stored in database 10H may thereafter be transmitted to, and/or stored in, database(s) 20H and/or 30H of the respective individual computer(s) 20 and/or employee computer(s) 30. The operation of system 100 will thereafter cease at step 202.

If at step 203, system 100 determines that the individual is not applying for formal membership recruitment, the data stored at step 205 is stored in database 10H for later use or reference by any individual, employee, and/or operator or administrator of system 100. Some or all of the data stored in database 10H may thereafter be transmitted to, and/or stored in, database(s) 20H and/or 30H of the respective individual computer(s) 20 and/or employee computer(s) 30. The operation of system 100 will thereafter cease at step 206.

If, at step 203, it is determined that the individual wants to apply for sorority or fraternity formal membership recruitment, the operation will proceed to step 204. At step 204, the individual data, whether specific, generic, and/or general, is transmitted to the employee and/or administrator computer 30. Any data described as being transmitted between the parties, and/or between the respective computers, can be transmitted electronically, such as via e-mail, electronic message transmission, telephone call, telephone message, facsimile transmission, pager message, and/or physical mail delivery. The employee can review the data, at step 204, and transmit a response to central processing computer 10. The operation of system 100 will thereafter proceed to step 207.

At step 207, it is determined that the potential members and each club is interested in proceeding with the recruitment process, pursuing the clubs they would like to be invited back to the next round of events. At step 207, central processing computer 10 processes the potential member preferences and, at step 209, transmits the data to the employee and/or the administrator computer 30 associated with the employee. Additionally, at step 207, central processing computer 10 processes the all clubs individual preferences and, at step 209, transmits the data to the employee and/or the administrator computer 30 associated with the employee.

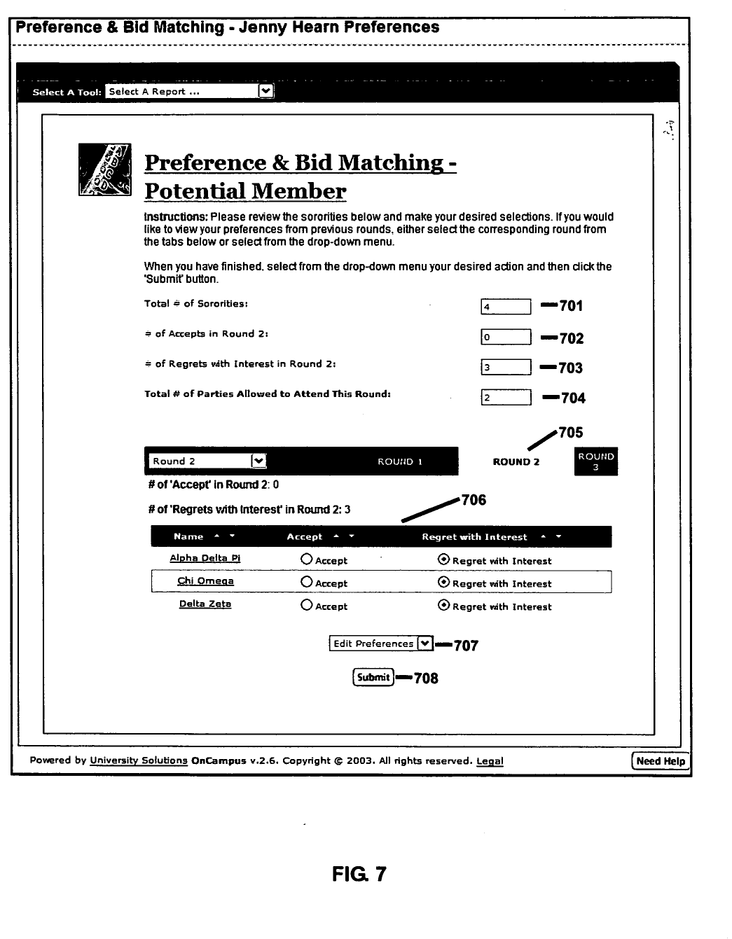

As seen in FIG. 7, the potential member is able to view various information about the formal membership recruitment including: in field 701—total number of sororities currently participating in formal membership recruitment, in field 702 number of accepts in the current round (round 2), field 703, field 703—number of regrets with interest in current round (round 2), field 704—total number of parties the potential member is allowed to attend for this round. Additionally, the potential member is defaulted to the current round in field 705, and is shown a list of sororities that they must either ‘accept’ or ‘regret with interest’ in field 706. Upon completion of making their preference selections, the potential member has the option at field 707 with the drop down box to either edit their preferences, save their preferences, print their preferences, or submit their preferences to the administrator. At field 708, the potential member can select the submit button to save and submit their preferences to the administrator.

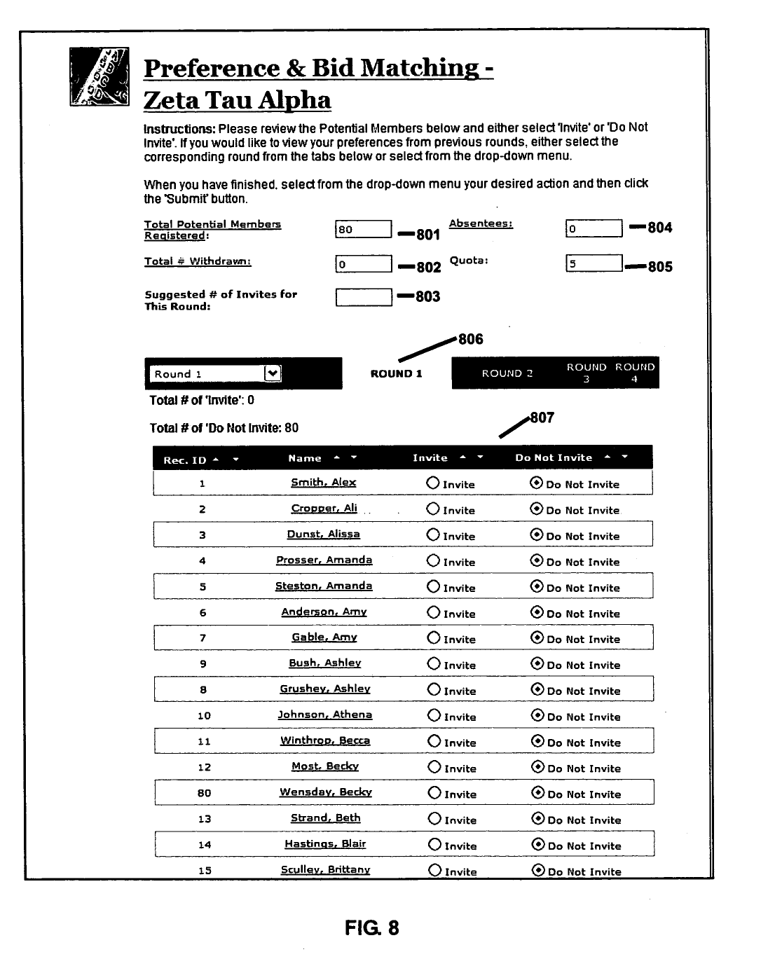

At step 207, it is determined that each individual club proceeds with the recruitment process, pursuing the potential members they would like to invite back to the next round of events. As seen in FIG. 8, the individual club or sorority is able to view various information about the formal membership recruitment including: field 801—total potential members registered, field 802 total potential members withdrawn, field 803—suggested number of invited for this round (optional field to be populated based on the administrator settings and configuration), field 804—absentees (those potential members that could not make it to a specific round or set of events), field 805—quota. Additionally, the individual club is defaulted to the current round in field 806, and is shown a list of all potential members that they must either ‘Invite’ or ‘Do Not Invite’ them back to the next round of parties at field 807. The data in the individual's response will, at step 209, be transmitted to the employee and/or administrator computer 30 associated with the employee.

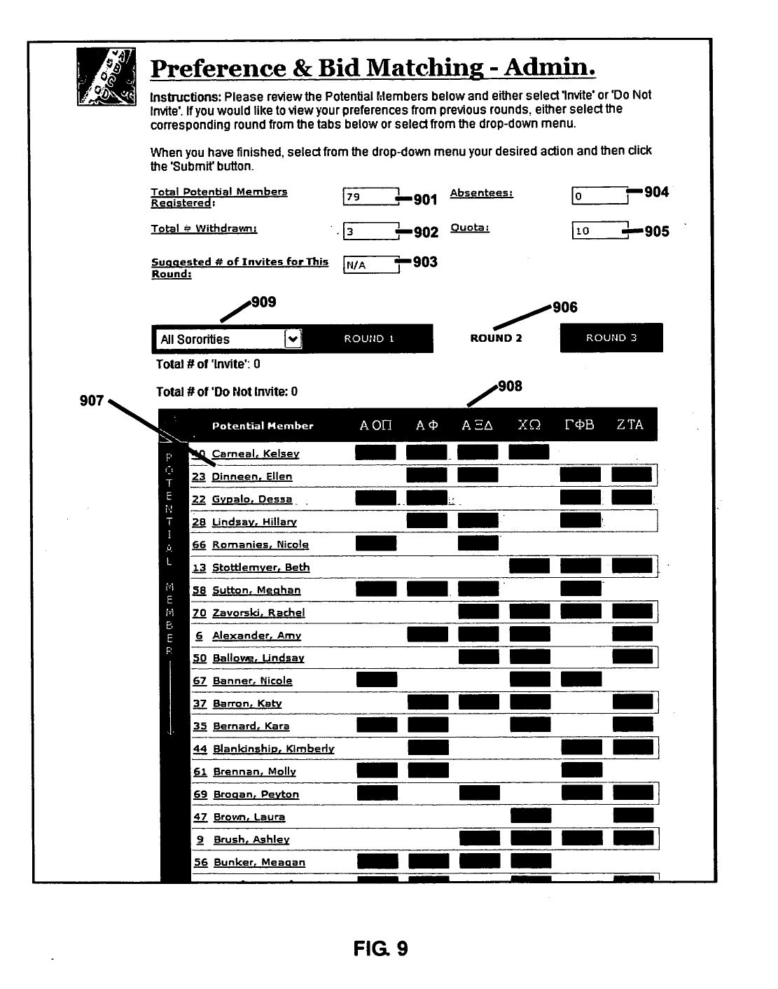

As seen in FIG. 9, the employee or administrator can view a variety of reports based on the submissions from the potential members and individual sororities at step 207. FIG. 9 displays one particular report a employee can view regarding the submissions during formal membership recruitment including: field 901 total number of potential members registered, field 902 total number of potential members withdrawn from formal membership recruitment, field 903 suggested number of invites for this round (optional field to be populated based on the administrator settings and configuration), field 904 absentees (those potential members that could not make it to a specific round or set of events), field 905 quota. Additionally, the employee and/or administrator is defaulted to the current round in field 906, and is shown a summary report matrix of all potential members names in field 907 and each sorority that they chose to ‘accept’ and invitation from in field 908 (The black box indicates and ‘accept’ preference.) In field 909, the employee or administrator can select from a drop down menu a variety of other reports that display various other formal membership recruitment information and data for past or current rounds.

Data for step 207 may also be entered into central processing computer 10 by uploading and/or downloading, whichever the case may be, the preferences of both the potential member, each individual club, and/or any other pertinent data. Data may also be obtained via a questionnaire which may be provided and/or answered on-line. Any and/or all of such data may be stored in database 10H.

Central processing computer 10 can also process the specific data in order to convert and/or separately store same as generic data. Any and all data stored at step 209, and/or previously, can be stored in database 10H of central processing computer 10, in databases 20H and/or 30H, respectively, of individual computer 20 and/or employee computer 30, as appropriate. The employee and/or administrator can review the data from all submissions at step 207, and record the mutual preferences at step 209. If, at step 210, it is determined that the potential member is interested in continuing with the recruitment process, central processing computer 10 will proceed to step 213 and proceed with the specific data. If, however, at step 210, it is determined that the potential member is not interested in continuing with the recruitment process, central processing computer 10 will proceed to step 211 and proceed with the generic and/or general data. Thereafter, the operation will proceed to step 212.

At step 213, the employee and/or administrator can review the data from all submissions at step 207. Thereafter, central processing computer 10 will determine whether each individual club wants to invite back each individual potential member to the next scheduled event. If, at step 213, it is determined through mutual preference that the either the potential member does want to pursue a particular club further and/or the club does want to pursue a particular potential member further, central processing computer 10 will, at step 219, schedule the potential members and individual clubs that mutually selected one another.

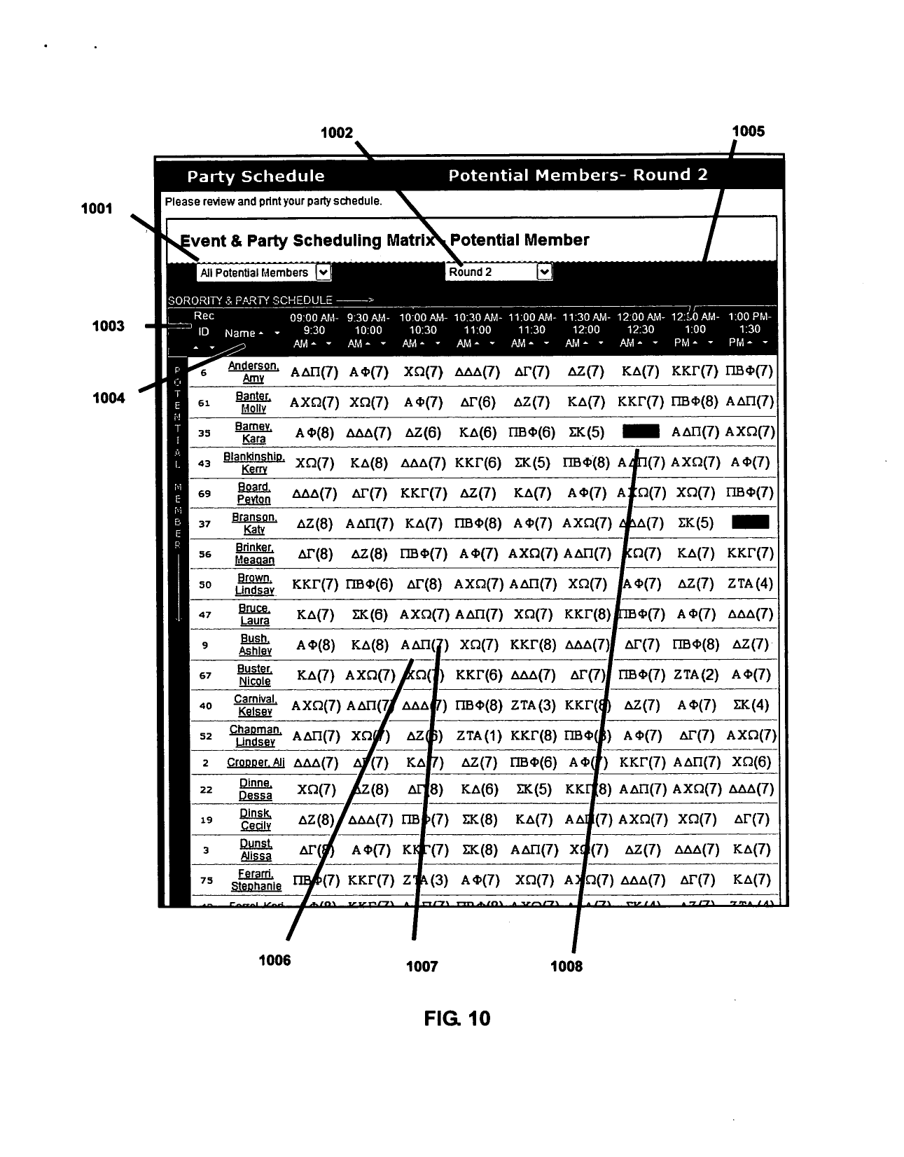

As seen in FIG. 10, the employee or administrator can view a variety of reports based on the submissions from the potential members and individual sororities at step 207. FIG. 10 displays one particular report a employee can view regarding the submissions during formal membership recruitment including: field 1001 can display a variety of reports from a drop down menu that show various other formal membership recruitment information (for example, and administrator can select an individual sorority's party schedule to view and the report displayed will automatically refresh with the appropriate report.). Field 1002 is defaulted to the current round of events. The administrator may also select a past round from the drop down menu (i.e. Round 1) to view the data for this round. Field 1003 displays the header row of the Recruitment ID field for each potential member. During formal membership recruitment, each potential member is issued a unique recruitment identification number to distinguish them from other potential members as they progress through all recruitment activities. Field 1004 displays the header row of the Name field which displays the potential member name. Field 1005 displays the header row of the Party Schedule. The times for each party are configured by the employee and/or administrator during Administrator Setup and can vary both in number and duration based on the institution using the application. Field 1006 displays the name of the organization (in this case a sorority) with the abbreviated Greek letters and field 1007 displays the number of potential members currently attending this event. This matrix or grid can be read the following way: potential member Ashley Bush—Recruitment ID: 9, is currently scheduled to attend Alpha Delta Pi's (ΔΔΠ) event from 10:00 AM-10:30 AM. There are currently a total of seven (7) potential members that will also be attending this event. Field 1008 displays a black box that indicates and opening or vacancy in the party schedule. In this example, potential member Kara Barney, Recruitment ID 35, currently has not party scheduled from 12:00 AM-12:30 AM. At step 215 in FIG. 5B, the employee and/or administrator is able to see that there is an opening for potential member Kara Barney. At step 218, the administrator can optionally schedule another party for Kara to maximize her exposure to all other sororities (in this example) during formal membership recruitment.

At step 220, central processing computer 10 will provide to both potential members and each club a report or list of available individuals either electronically and/or otherwise. The results at step 220 can also be provided to the employee by being displayed on display device 30E and/or by being printed via the output device or printer 30I.

If, at step 213, it is determined through mutual preference that the either the potential member does not want to pursue a particular club any further and/or the club does not want to pursue a particular potential member any further, central processing computer 10 will not, at step 214, automatically schedule the potential members and individual clubs for the next round of events. At step 215, the employee and/or administrator will view the reports at step 220 generated by central processing computer 10 to determine if there are any openings in the schedule of events. At step 218, it is determined that there are openings in the schedule of events, the employee and/or administrator may optionally schedule a potential member for a next event—to maximize their exposure to all clubs—and add them to an open slot in the schedule. Thereafter, the operation will proceed to step 220. At step 216, it is determined that there are no openings in the schedule of events, the administrator and/or employee can decide not to schedule the potential member with a particular club. Thereafter, the operation will proceed to step 217.

At step 220, it is determined that the employee and/or data, whether specific, generic, and/or general, is transmitted to the potential members, individual clubs, individual and/or individual computer 20. Any data described as being transmitted between the parties, and/or between the respective computers, can be transmitted electronically, such as via e-mail, electronic message transmission, telephone call, telephone message, facsimile transmission, pager message, and/or physical mail delivery. The individual can review the data, at step 220.

The data stored at step 220 is stored in database 10H for later use or reference by any individual, employee, and/or operator or administrator of system 100. Some or all of the data stored in database 10H may thereafter be transmitted to, and/or stored in, database(s) 20H and/or 30H of the respective individual computer(s) 20 and/or employee computer(s) 30.

Steps 207 through step 220 are repeated for every ‘round’, ‘set’, ‘party’, or ‘event’, leading up to the final selections (hereinafter referred to as ‘rounds’). Based on mutual preference, each successive round of events gradually narrows the candidates for both the potential members and the clubs that they are scheduled to visit. The number of rounds varies from school-to-school, based on factors such as: the number of potential members that have registered, the number of clubs participating in formal membership recruitment, the amount of time they have to conduct formal membership recruitment, or any/all other factors that would allow them to differentiate their schedule based on their specific needs.

At step 221, it is determined that the individual is interested in proceeding through the last round of invitational parties or “preference round”. Both the PM's and sororities submit their top selections for consideration of being asked to join an individual sorority. The data (or preferences) for both the individual and each sorority response will, at step 209, be transmitted to the employee and/or administrator computer 30 associated with the employee.

Data for step 209 may also be entered into central processing computer 10 by uploading and/or downloading, whichever the case may be, the preferences of both the potential member, each individual club, and/or any other pertinent data. Data may also be obtained via a questionnaire which may be provided and/or answered on-line. Any and/or all of such data may be stored in database 10H.

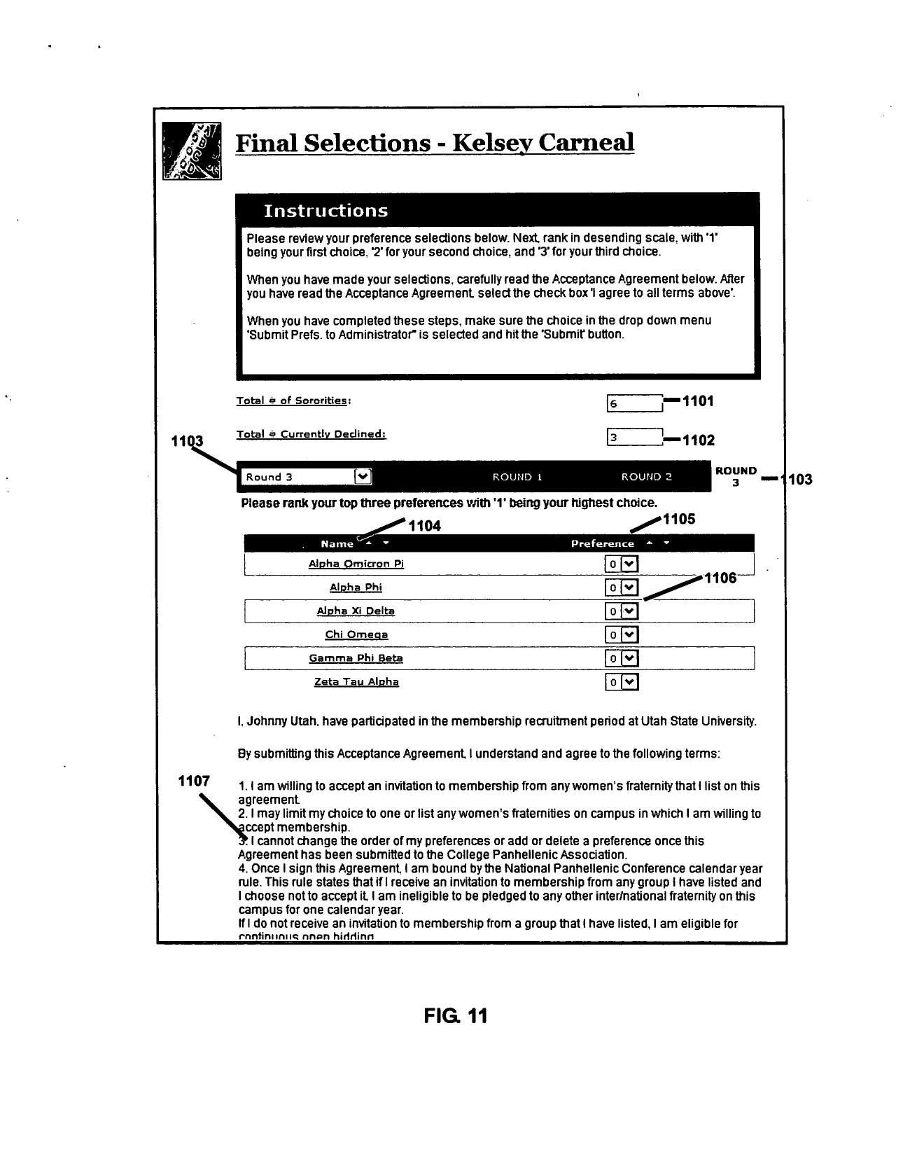

As seen in FIG. 11, the application displays the final selections for the potential member. Field 1101 displays the total number of clubs (in this example, sororities) that are participating in formal membership recruitment. Field 1102 displays the total number of clubs that have been declined by the potential member thus far. Field 1103 displays in two areas the current round of events. The drop down menu will allow the potential member to select a previous round to view their previous choices. Field 1104 displays the header row Name which contains all of the clubs participating in formal membership recruitment. Field 1105 displays the header row Preference which contains a drop down menu selections. Field 1106 displays the drop down menu selections with numerical preferences (starting with zero (0) and going up to three (3)). The potential member must review their preferences of clubs in descending scale with ‘1’ being their first preference choice, ‘2’ being their second preference choice, and ‘3’ being their third preference choice. Field 1107 displays the membership acceptance agreement (‘preference card’ and/or ‘contract’) that the potential member must agree to before their selections will be considered for the matching process beginning at step 221. Upon agreeing to the membership acceptance agreement, the potential member's selections are submitted to the employee and/or administrator.

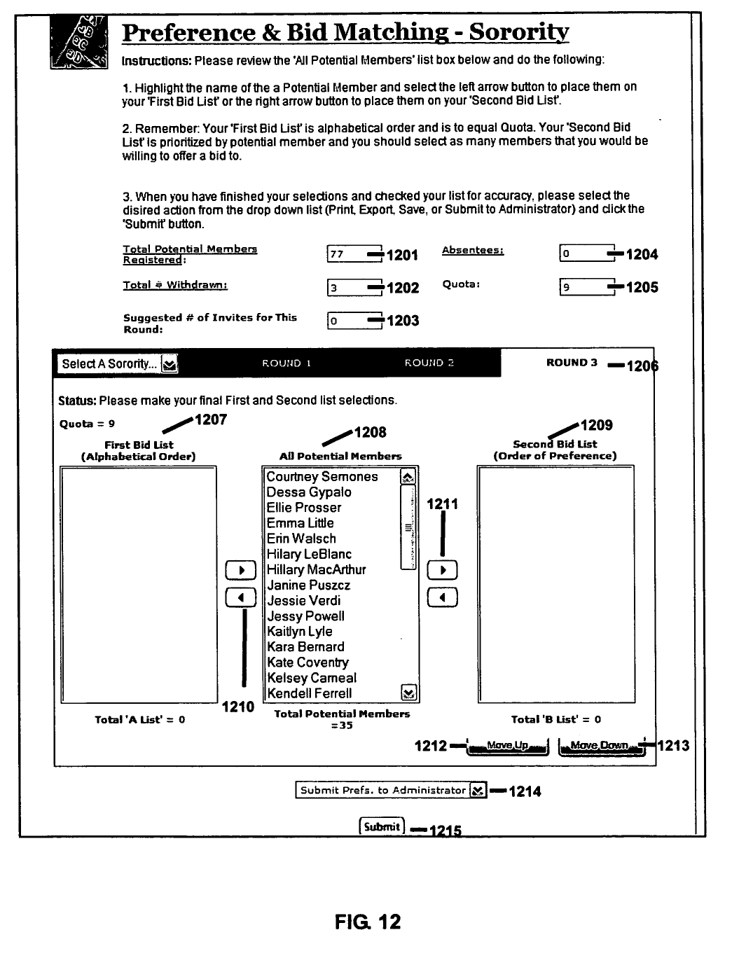

As seen in FIG. 12, the application displays the final selections for the each individual club (in this case a sorority). Field 1201 displays the total number of potential member registered. Field 1202 displays the total number of potential members who have since withdrawn from formal membership recruitment. If the user selects the text ‘Total # Withdrawn” this will bring them directly to the Withdraw Report. This linking is also true for all other data element titles on this page that are underlined. Field 1203 displays (optionally, if the administrator and/or employee configured the application this way) the suggested number of invites for this round. Field 1204 displays any potential members who were absent from any events. Field 1205 displays the quota as set by the administrator. Field 1206 displays the current round of events. Field 1207 displays the first bid list data element box that allows this sorority to add potential members to their first bid list. Field 1208 displays a list of all potential members that this sorority is considering offering a invitation or ‘bid’ to. Through mutual selection in the previous rounds, this list has been narrowed down. To add a potential member to the first bid list in field 1207, the sorority would select the name of the desired potential member in field 1208, and select the left arrow button in field 1210. This will remove the potential members name from field 1208 and add it to field 1207. As more potential members are added, the application will sort their names alphabetically, by last name in descending order. The maximum amount of potential members allowed on the first bid list is equal to quota. Field 1209 displays the second bid list. To add a potential member to the second bid list in field 1209, the sorority would select the name of the desired potential member in field 1208, and select the right arrow button in field 1211. This will remove the potential members name from field 1208 and add it to field 1209. Field 1212 allows the club to ‘move up’ a potential member on the second bid list. Field 1213 allows the club to ‘move down’ a potential member on the second bid list. The second bid list is prioritized by potential member name. The amount of potential members allowed on this list is as many as this particular club would be willing to extend a bid to. To ‘move up’ a potential member on the second bid list in field 1209, the sorority would select the name of the desired potential member, and select the ‘move up’ button in field 1212. This will move the potential member up one position or ‘slot’ on the second bid list. Field 1214 displays a drop down menu that allows the sorority several options. As displayed, they may ‘Submit Prefs. To Administrator’ which submits their preferences to the employee and/or administrator. They may also print their final selection and/or may also export their final selections to another program. The selection in the drop down menu is executed when the club selects their desired action and then selects the ‘Submit’ button at field 1215.

Central processing computer 10 can also process the specific data in order to convert and/or separately store same as generic data. Any and all data stored at step 209, and/or previously, can be stored in database 10H of central processing computer 10, in databases 20H, and/or 30H, respectively, of individual computer 20 and/or employee computer 30, as appropriate. The employee and/or administrator can review the data from all submissions at steps 221, and record the final selections at step 209. At step 221, it is determined that the potential members who chose not to sign and/or accept an online contract and/or acceptance agreement as stipulated by the employee and/or administrator, central processing computer 10 deletes the names of those potential members. Thereafter, the first bid lists and the second bid lists will be adjusted according to Steps 1a-1c—Sorority Rushing Instructions.

At step 222, central processing computer 10 will review the data from all submissions at step 221 and alphabetize the potential member's names according to last name first in descending order. Thereafter, the operation will proceed to step 223. At step 223, central processing computer 10 will initially set the “LimitMatch=1”, where LimitMatch equals the first preference choice of a potential member for a particular sorority. Central processing computer 10 will review all choices and attempt to match the potential member's with their first preference choice. LimitMatch will equal ‘1’ (LimitMatch=1) as long as there is the possibility to match the potential member to the sorority of their first choice. Thereafter, LimitMatch will then be equal to ‘2’ (LimitMatch=2). as long as there is the possibility to match the potential member to the sorority of their second choice. Thereafter, LimitMatch will then be equal to ‘3’ (LimitMatch=3). as long as there is the possibility to match the potential member to the sorority of their third choice. Thereafter, the operation will proceed to step 224.

At step 224, central processing computer 10 will analyze the preferences from an array of all potential members for LimitMatch. Thereafter, the operation will proceed to step 225. If, at step 225, it is determined through mutual preference that potential member is on the first bid list of the sorority they made their first preference choice to (LimitMatch=1 or “mutual selection”), central processing computer 10 will match the potential member to this particular sorority. Thereafter, at step 226, central processing computer 10 will delete this potential member from all other sorority first and second bid lists. Additionally, central processing computer 10 will adjust all other sorority bid lists. Each sorority bid list is equal to quota as set by the employee and/or administrator. The first bid list of each sorority is always equal to quota (Q). At step 226, it is determined which sororities first bid list is equal to Q−1. Thereafter, the first name on the second bid list will be moved over to the last space of the first bid list. Additionally, each name on the second bid list will move up one space on the second bid list. Thereafter, the operation will proceed to step 227.

If, at step 227, it is determined through central processing computer 10 that the quota has not been reached for this sorority, the operation will proceed to step 234. If, at step 227, it is determined through central processing computer 10 that the quota has been reached for this sorority, the operation will proceed to step 228.

At step 228, it has been previously determined that the quota has been reached for this sorority. Therefore, this sorority will be deleted from all other potential member's preference lists (including the preferences on ‘hold’). Thereafter, the operation will proceed to step 229. If, at step 229, it is determined through central processing computer 10 that of the potential members that were identified from step 228, there are potential members who have not listed another choice of a sorority on their preference lists, the operation will proceed to step 230.

If, at step 229, it is determined through central processing computer 10 that of the potential members that were identified from step 228, there are potential members who have listed another choice of a sorority on their preference lists, the operation will proceed to step 234. At step 230, it is determined through central processing computer 10 that the potential member is unmatched, the operation will proceed to step 235. If, at step 235, it is determined through central processing computer 10 that there are potential members that are not on hold, the operation will proceed to step 236. At step 236, it is determined through central processing computer 10 that the potential member is unmatched, the operation will cease. At step 236, the employee and/or administrator can review the data from step 236. At step 236, central processing computer 10 will provide to the employee and/or administrator a report or list of available individuals either electronically and/or otherwise. The results at step 236 can also be provided to the employee by being displayed on display device 30E and/or by being printed via output device or printer 301.

If, at step 225, it is determined through mutual preference that potential member is on not on the first bid list of the sorority they made their first preference choice to (LimitMatch=1 or “mutual selection”), central processing computer 10 will proceed to step 231. If, at step 231, it is determined through central processing computer 10 that the potential member does have other choices on their preference list, the operation will proceed to step 232. At step 232, it is determined through central processing computer 10 that the potential member does have other choices on their preference list. Thereafter, central processing computer 10 will delete this potential member from all other sorority first and second bid lists. Additionally, central processing computer 10 will adjust all other sorority first and second bid lists. Each sorority bid list is equal to quota as set by the employee and/or administrator. The first bid list of each sorority is always equal to quota (Q). At step 232, it is also determined which sororities first bid list is equal to Q−1. Thereafter, the first name on the second bid list will be moved over to the last space of the first bid list. Additionally, each name on the second bid list will move up one space on the second bid list. Thereafter, the operation will proceed to step 233.

If, at step 231, it is determined through central processing computer 10 that the potential member does not have other choices on their preference list, the operation will proceed to step 233. At step 233, it is determined through central processing computer 10 to place the potential member on hold for the next ‘read through’. Thereafter, the operation will proceed to step 234. If, at step 234, it is determined through central processing computer 10 that there is a potential member whose preferences were not processed at least once, the operation will proceed to step 235. Otherwise, at step 234, it is determined through central processing computer 10 that there is a potential member who's preferences were processed at least once, the operation will proceed back to step 224 to do a second ‘read through’.

If, at step 235, it is determined through central processing computer 10 that there are potential member's on hold, the operation will proceed to step 237. If, at step 237, it is determined through central processing computer 10 that there are potential member's who have matched since the last reading of the potential member's list, the operation will proceed to step 238. At step 238, it is determined through central processing computer 10 to read the next potential member on hold, the operation will proceed back to step 225. If, at step 237, it is determined through central processing computer 10 that there are potential member's who have not matched since the last reading of the potential member's list, the operation will proceed to step 239.

If, at step 239, it is determined through central processing computer 10 that the LimitMatch <3, the operation will proceed to step 240. At step 240, it is determined through central processing computer 10 to read LimitMatch=2 and LimitMatch=3 respectively, the operation will proceed to step 224. If, at step 239, it is determined through central processing computer 10 that the LimitMatch is not <3, the operation will proceed to step 241. At step 241, it is determined through central processing computer 10 that there is a ‘gridlock’ position.

As stipulated in the NPC Manual of information, they discuss how to break a blocked or grid lock condition:

“Occasionally, in bid-matching, a block or grid lock condition may occur. This happens when, after several readings of the preferences listed on Membership Recruitment Acceptances which have been placed on hold, it is no longer possible to match a woman's preference to a fraternity's bid list.

The following procedure will break this block, or grid lock condition, allowing normal bid-matching to resume.

Using the bid list of the woman's first choice fraternity, determine the number of the fraternity's confirmed matches at that point (i.e., the number of names listed in the center column of that fraternity's bid list). Add that number to the total number of unmatched names which precede the name of the woman under consideration.

Add only the preceding names which also have named this same fraternity as their first choice.

If the sum equals or is greater than Quota, it is obvious that the fraternity will be matched to its Quota before the name of the woman in question can be read. At this point the Reader calls the woman's second choice fraternity and the bid-matching can continue.

If the woman's second choice is not matched at this reading, her Membership Recruitment acceptance is placed again in the hold category, and bid-matching is resumed.” [National Panhellenic Conference, Manual of Information, Thirteenth Edition, 1999., pgs. 10-11.]

Thereafter, the operation will proceed to step 224.

In any and/or all of the embodiments described herein, any electronic messages, such as e-mails, electronic message transmissions, pager messages, telephone calls or messages, facsimile transmissions, etc., which are generated by central processing computer 10, by individual computer 20, and/or by employee computer 30, may contain appropriate hyperlinks, and/or forwarding information, to the party sending the electronic message and/or e-mail, to a third party, to other information, and/or to another information source. In this manner, for example, an e-mail message, transmitted from and/or on behalf of an employee to an individual, can contain a hyperlink(s) to the school, institution, organization, or employee web site or web page.

In another preferred embodiment of the present invention, various other functions may be achieved. In this case, central processing computer 10 may be configured to provide an employee with conditions under which the individual and/or individuals will agree to a reservation, an engagement, and/or a request. One of these conditions can include payment in advance, a down payment, and/or an option payment, for the services of the individual or individuals. In this embodiment, central processing computer 10 can administer and/or maintain a financial account for, or on behalf of any of, the individuals and/or employees described herein. The financial accounts may be bank accounts, electronic money accounts, credit accounts, debit account, and/or any other accounts for facilitating financial transactions. Central processing computer 10 can make a payment and/or transfer, on behalf of an employee, from the employee's account, to an individual's account or to accounts of individuals, thereby receiving payment for, or on behalf of, the individual or individuals, whichever the case may be.

An individual may utilize the schedules and/or scheduling data, events, and/or information in order to inform other individuals and/or groups of social and/or administrative events. An individual can access central processing computer 10 and invite and/or notify other individuals and/or groups information concerning upcoming social and/or administrative events. The invited individual(s) may review the schedules and/or scheduling data, events, and/or information, on their calendars or ‘This Weeks Events’. The invited individual(s) may receive the message in real-time and/or otherwise. The invited individual(s) may thereafter accept or reject the offer via transmitting a message from the inviting individual computer 30 to central processing computer 10. Thereafter, central processing computer 10 will transmit a message to individual computer 20 of the individual, thereby notifying the individual of the acceptance or rejection of the event.

In another preferred embodiment, as well as in any and/or all of the embodiments described herein, the present invention can generate electronic catalogs, electronic handbooks, and/or electronic coupons for use by employee, to publicize and/or to advertise to members and/or groups of their application on behalf of pre-selected employee partners and/or their agents and/or representatives, to publicize and/or to advertise their services, and/or the services of those who they represent.

In this manner, an employee can generate and/or distribute electronic catalogs, electronic handbooks, and/or electronic coupons, thereby publicizing and/or advertising any events, products, and/or services, and electronically distribute same to individuals, groups, and/or membership organizations who or which can be identified by querying database 10H and/or by utilizing any other appropriate search method and/or criteria. Individuals, and/or their representative(s), may generate and/or distribute electronic catalogs, electronic handbooks, and/or electronic coupons in order to publicize and/or to advertise their own events, products, and/or services to other individuals, members of their own organization, and/or other authorized organizations.

Any and/or all of the electronic catalogs, electronic handbooks, and/or electronic coupons described herein can be generated automatically by central processing computer 10, by any individual computers 20, and/or employee computers 30. Any of central processing computer 10, individual computer(s) 20 and/or employee computer(s) 30 can be programmed to generate and/or to transmit any of the e-mails, electronic message transmissions, electronic catalogs, electronic handbooks, and/or electronic coupons described herein.

In another preferred embodiment, the system and method of the present invention can be utilized for performing and/or for facilitating the provision of recruitment services for schools, colleges, universities, and/or any organizations of any kind. In this embodiment, information in the form of text messages, video messages, audio messages, video clips, audio clips, infomercials, electronic catalogs, e-mail messages, etc., for publicizing and/or for promoting any of the herein-described schools, colleges, universities, and/or any organizations of any kind, can be stored at central processing computer 10 and can be provided to any individuals who or which utilizes the system and method of the present invention.

The system and method of the present invention can also provide and/or facilitate the provision of any of the herein-described recruiting and/or recruitment services for attracting individuals to, and/or recruiting individuals for, any of the respective schools, colleges, universities, and/or any organizations of any kind.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of a respective individual, and/or employee, so as to perform any of the formal membership recruitment searches, database searches, and/or any of the other activities and/or functions described herein. The intelligent agent can act on behalf of the individual, and/or employee, in various related interactions, preference selections, and/or other activities which are described as being performed herein and/or which may be incidental and/or related thereto.

An individual can utilize an intelligent agent(s) in order to find, identify, and/or locate a member in the said application. In a similar and/or an analogous manner, the employee can utilize an intelligent agent(s) in order to find and/or locate individuals.

In any and/or all of the embodiments described herein, the present invention can provide links and/or hyperlinks, on-line, on-screen, in e-mail messages and/or in electronic message transmissions, and/or otherwise, to any and/or all products and/or services related to membership organizations and/or the sorority or fraternity formal membership recruitment process. For example, the present invention can provide links to information regarding the website location of a national club or organization, links to background or statistical information on said clubs or organizations, links to other partnership companies such as, but not limited to, links to a travel agents, links to collegiate wearables, links to Greek wearables, links to transportation companies, rental car companies, hotels and other lodging establishments, as well as links to school supplies, formal membership recruitment supplies, on and off-campus living supplies, etc.

The present invention can also be utilized in order to prevent certain individuals and/or entities, from accessing the data about any other individual, entity, employee, and/or member. Access restrictions to any data can be effected by utilizing any data security and/or access prevention methods, technologies and/or techniques, known by those skilled in the pertinent arts.

The system of the present invention can also be configured in order to automatically generate and/or transmit any of the e-mails, electronic message transmissions, electronic notification transmissions, and/or any of the communications, which are described herein, between any of the parties which utilize the present invention.

In another preferred embodiment, as well as in any and/or all of the embodiments described herein, the present invention can be utilized in order to monitor, record, and/or keep track of, any preferences and selections of all individuals involved during the formal membership recruitment process including: preferences of both potential members and sororities after the conclusion of each round and/or set of parties, recruitment or release figure statistical information on said groups, aggregate formal membership recruitment statistics, surveys and polling information, legacy list report information, which occur in conjunction with and/or via use of the present invention. The information which is obtained can thereafter be provided to individuals, employees, and/or other designated national membership organization, for utilization in any appropriate and/or suitable manner.

In any and/or all of the embodiments described herein, any individual and/or employee data can be stored with various and/or varying levels of specificity and/or confidentiality. In this manner, any of the data described herein, can be filtered, can be released at varying times, depending upon the interest and/or comfort levels of the parties, and/or can be maintained as confidential. In this manner, the respective parties can maintain confidentiality and/or can exercise control over the nature and amount of data which can be released about themselves.

The system and/or method of the present invention can be utilized as an electronic and/or network-based membership organization and/or formal membership recruitment system and/or clearinghouse.

In any and/or all of the embodiments described herein, any preferences, selections, final selections, bid matching, and/or preference matching between any of the parties, can be monitored and/or be recorded by central processing computer 10 and be stored in database 10H. In this regard, any preferences, selections, final selections, bid matching, preference matching, and/or communications, actions and responses thereto, can be recorded and/or be stored and utilized in any manner consistent with the operation and/or use of the present invention as described herein.

In another preferred embodiment, as well as in any and/or all of the embodiments described herein, the present invention can be utilized in order to administer and/or maintain a financial account for, or on behalf of any of, the individuals, clubs and/or employees described herein, including but not limited to: national dues collections between active members of clubs and their respective national headquarters, national dues collections between active newly initiated members of clubs (‘pledges’ or ‘new members’) and their respective national headquarters, local dues collections active members of clubs and their respective local club or ‘chapter’ (for example, undergraduate chapters on a college campus), local dues collections active members of local alumnae clubs and their respective local club or ‘chapter’ (for example, the alumni chapter of a particular institution at a particular city), and any/all other such financial collections as needed by such organizations (for example, t-shirts, fundraisers, formal events, etc.) The financial accounts may be bank accounts, electronic money accounts, credit accounts, debit account, and/or any other accounts for facilitating financial transactions. Central processing computer 10 can make a payment and/or transfer, on behalf of an employee, from the employee's account, to an individual's account or to accounts of individuals, thereby receiving payment for, or on behalf of, the individual or individuals, whichever the case may be.

In another preferred embodiment, as well as in any and/or all of the embodiments described herein, the present invention can be utilized in order to more effectively communicate, collaborate, and share information amongst, local members of clubs or chapters, alumni/alumnae chapters, and their respective national organizations. The present invention can be utilized in order to administer and/or maintain a centralize intranet for, or on behalf of any of, the individuals, clubs, and/or employees described herein, including but not limited to: national and local undergraduate and alumni database, centralize reporting functions for authorize individuals (for example, national statistics on membership numbers, grades, financial status of individual chapters, etc.), educational communications (for example, alcohol awareness, effective study habits, leadership, and other such campaigns), centralized ‘knowledge center’ allowing such members to upload or ‘post’ internal documents pertinent to the organization (for example, ‘industry best practices’, forms, policies, procedures, etc.), national to local surveys and polling tools, branded websites for local, regional, and national chapters, and/or targeted communications amongst such members (for example, newsletters, marketing emails, fundraising emails, etc.)

In another preferred embodiment, as well as in any and/or all of the embodiments described herein, the present invention can be utilized in order to administer and/or maintain a post-graduate matching system that contains a competitive recruitment situation (for example, internships and residency positions). Fields such as, but not limited to: medicine, law, dentistry, accounting, pharmacy, podiatry, and placement of university intern & co-op students are examples of such verticals.

In another preferred embodiment, as well as in any and/or all of the embodiments described herein, the present invention can be utilized in order to administer and/or maintain a system for matching individuals for ‘paired’ living situations. For example, as high school seniors accept the college/university of choice, a majority of incoming freshmen are required to live on campus. Most institutions rely on a random or ‘lottery’ type system of matching roommates for the various dormitories. The present invention can allows such individuals to answer a series of questions based on, but not limited to: major or intended field of study, study habits, sleeping habits, musical preferences, hobbies, activities, interests, smoker/non-smoker, etc. These ‘compatibility’ preferences can be compared to individuals with similar interests to ultimately match said individuals with one another to become roommates.

The benefits of allowing ‘active participation’ amongst said individuals are, but are not limited to: reducing room/roommate conflicts, reduce housing management administration, time, and costs associated with relocating incompatible roommates, and intelligently streamline the process of roommate matching reducing the manual and administrative burden of matching said individuals.

In another preferred embodiment, as well as in any and/or all of the embodiments described herein, the present invention can be utilized in order to administer and/or maintain a system or a social event that involves meeting several other individuals in a single evening and mutually selecting one another for the purpose of social and/or personal relationships, commonly referred to as ‘speed dating’.

Speed Dating is a recent, widely-popular craze that is sweeping the US, Europe and other countries worldwide. Events or parties are usually held in local establishments (for example, bars/restaurants/lounges) in various cities. There is usually a predetermined list that consists of an equal number of men and women who are interested in meeting other ‘singles’. Each individual will have a ‘speed date’ with other individuals (male/female) and have a ‘score’ or ‘preference’ card. After each date, each person selects a “Yes” or “No” next to each person's name/number to indicate if they would like to see them again. If two people that met mutually checked “Yes”, it is considered a ‘match’. The usual protocol is to exchange some form of contact information between the parties so that they may get in touch with one another for another date (name/email/etc.) The prior art for this field has been a manual process and is labor intensive.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A system for providing club and/or membership information, comprising:
a memory device for storing information regarding the personal profile of members of at least one of a club, organization, fraternity, sorority, and information regarding a said organizations;
a processing device for processing the mutual preferences of information regarding the sorority and fraternity formal membership recruitment processes, wherein the processing device is programmed to manage the coordination and logistics for the rounds, or “sets” of parties that make up the formal membership recruitment process; and
a transmitter for transmitting the message to a communication device associated with an individual, wherein the message is transmitted to the communication device in real-time.

2. The system of claim 1, wherein the communication device is at least one of a personal computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and a watch.

3. The system of claim 1, wherein the system is activated automatically upon the occurrence of the registration event.

4. The system of claim 1, wherein the information regarding the at least one of an individual registering to become a member of such clubs, organizations, fraternities, sororities, or other social or administrative groups, is automatically received by the receiver and automatically stored in the memory device.

5. The system of claim 1, wherein the information regarding the registration to be admitted to such organizations is transmitted to the receiver from at least one of the communication device and a third communication device associated with the individual, and further wherein the information regarding the registration request is automatically received by the receiver and automatically stored in the memory device.

6. The system of claim 1, wherein the information regarding the registration to be admitted to such organizations contains at least one of information regarding an individual, an individual's personal contact information, an individual's educational background, an individual's relation to any relatives who were also part of such organizations, an individual's hobbies and interests, and an individual's authorization to release their grades to determine academic eligibility of joining such organizations.

7. The system of claim 1, wherein the message is transmitted as at least one of an electronic message transmission, a telephone call, a telephone message, a facsimile transmission, and a pager message.

9. The system of claim 1, wherein the message is transmitted as an e-mail message.

10. The system of claim 1, wherein the message contains at least one of an electronic catalog, text information, video information, and audio information.

11. The system of claim 1, wherein the message contains at least one of a hyperlink and a link to at least one of an educational institutions web site, a club and/or membership organization web page, information about a club or the membership organization(s), a video presentation about a club or the membership organization(s), information regarding a club or the membership organization(s), at least one of a benefit, a financial, and an operational, data or information, and an information source regarding a locale or area where an a club or the membership organization(s) is located.

12. The system of claim 1, wherein the system is utilized on or over at least one of the Internet, the World Wide Web, and a wireless communication network.

13. A system for providing recruitment information, comprising:
a memory device for storing information regarding at least one individual available for at least one of applying for and interviewing for at membership in a club or the membership organization(s);
a processing device for processing the mutual preferences of information regarding the sorority and fraternity formal membership recruitment processes, wherein the processing device is programmed to manage the coordination and logistics for the rounds, or “sets” of parties that make up the formal membership recruitment process; wherein the processing device is programmed to detect the occurrence of the recruitment processes, wherein the processing device utilizes information regarding the at least one individual stored in the memory device, and further wherein the processing device generates a message containing information regarding the at least one individual, wherein the message is responsive to the recruitment search request; and
a transmitter for transmitting the message to a communication device associated with the administrator, employee and/or membership organization(s), wherein the message is transmitted to the communication device in real-time.

14. The system of claim 13, wherein the communication device is at least one of a personal computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and a watch.

15. The system of claim 13, wherein the system is activated automatically upon the occurrence of the searching event.

16. The system of claim 13, wherein the information regarding the at least one individual registering to become a member of such clubs, organizations, fraternities, sororities, or other social or administrative groups, is automatically received by the receiver and automatically stored in the memory device.

17. The system of claim 13, wherein the system is a computer associated with at least one of the administrator, active members of such organizations, and potential new members of such organizations.

18. The system of claim 13, wherein the message is transmitted as at least one an electronic message transmission, a telephone call, a telephone message, a facsimile transmission, and a pager message.

19. The system of claim 13, wherein the message is transmitted as an e-mail message.

20. The system of claim 13, wherein the message contains at least one of an electronic catalog, text information, video information, and audio information.

21. The system of claim 13, wherein the message contains at least one of a hyperlink and a link to at least one of an individual's personal profile, a link to at least one of a college, a university, and a school, attended by an individual, a registrar's office of an individual's school, a video presentation or a video clip of an individual, and a photograph of the individual.

22. The system of claim 13, wherein the system is utilized on or over at least one of the Internet, the World Wide Web, and a wireless communication network.

23. An system for providing recruitment information, comprising:
a memory device for storing at least one of personal and/or public schedule information and scheduling information for at least one of an individual, a club, membership organization, fraternity, and/or sorority;
a receiver for receiving a first request, wherein the first request contains information regarding a request to obtain at least one of personal and/or public schedule information and scheduling information for at least one of an individual, a club, membership organization, fraternity, and/or sorority, wherein the first request is received from a first communication device associated with an individual or group;
a processing device for processing information contained in the first request, wherein the processing device generates a first message containing the at least one of personal and/or public schedule information and scheduling information for at least one of an individual, a club, membership organization, fraternity, and/or sorority; and
a transmitter for transmitting the first message to the first communication device,
wherein the receiver receives a second request, wherein the second request contains information for at least one of reserving, engaging, and requesting, the involvement and/or participation of the at least one of an individual, a club, membership organization, fraternity, and/or sorority, wherein at least one of the processing device processes the information contained in the second request and at least one of reserves, engages, and requests, the services of the at least one of an individual, a club, membership organization, fraternity, and/or sorority, the processing device generates a second message containing information regarding the second request, and the transmitter transmits a second message containing information regarding the second request to a second communication device associated with the at least one of an individual, a club, membership organization, fraternity, and/or sorority.

24. The system of claim 23, wherein the memory device for storing at least one of personal and/or public schedule information and scheduling information for a plurality of at least one of individuals, clubs, membership organizations, fraternities, and sororities.

25. The system of claim 23, wherein the processing devices processes information to generate a first message containing the at least one of personal and/or public schedule information and scheduling information for at least one of an individual, a club, membership organization, fraternity, and a sorority.

26. The system of claim 23, wherein the second request contains information regarding at least one of reserving, engaging, and requesting, the involvement and/or participation of the at least one of an individual, a club, membership organization, fraternity, and a sorority.

27. The system of claim 23, wherein the receiver receives a reply message transmitted from the second communication device, wherein the reply message contains information regarding at least one of a confirmation of the reservation, an agreement to the engagement, and a reply to the request, wherein the transmitter transmits a second reply message to the first communication device, wherein the second reply message contains information regarding at least one of the confirmed reservation, the confirmed agreement to the engagement, and the reply to the request.

28. The system of claim 23, wherein the system is programmed to at least one of confirm the reservation, engagement, and/or request, and issue a reply, for or one behalf of the at least one of an individual, a club, membership organization, fraternity, and a sorority.

29. The system of claim 23, wherein the system at least one of makes a payment or transfer from a financial account associated with the requesting individual, club, membership organization, fraternity, sorority, etc., receives a payment for a financial account associated with the at least one of an individual, club, membership organization, fraternity, sorority, etc., and administers a financial account for at least one of the individual, club, membership organization, fraternity, sorority, etc entity and the at least one of an individual, club, membership organization, fraternity, sorority, etc.

30. The system of claim 23, wherein the system is utilized on or over at least one of the Internet and the World Wide Web.

31. The system of claim 23, wherein the system is utilized with a wireless communication network.

32. The system of claim 23, wherein at least one of the first communication device and the second communication device is at least one of a personal computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and a watch.

33. An system for providing formal membership recruitment information, comprising:
a memory device for storing at least one of the preference choices of during the formal membership recruitment process and scheduling information for a potential member;
a receiver for receiving a first request, wherein the first request is a request to obtain at least one of the preference choices during formal membership recruitment and scheduling information for the administrator, wherein the first request is received from a first communication device associated with at least one of a potential member, potential new member, or rushee;
a processing device for processing information contained in the first request, wherein the processing device generates a first message containing the at least one of the preference choices during formal membership recruitment and scheduling information for the administrator; and a transmitter for transmitting the first message to the first communication device, wherein the receiver receives a second request, wherein the second request contains information regarding an offer to provide the preference choices during formal membership recruitment of the at least one of an individual, a potential member, a potential new member, and a rushee, to the administrator, wherein at least one of the processing device processes the information contained in the second request, the processing device generates a second message containing information regarding the preferences, and the transmitter transmits a second message containing information regarding the preferences to a second communication device associated with the sorority recruitment coordinator of a particular sorority.

37. The system of claim 28, wherein the memory device stores at least one of preference choices during formal membership recruitment and scheduling information for a plurality of administrators, wherein the at least one of preference choices during formal membership recruitment and scheduling information contains information regarding at least one of a date and a time when the administrator will release the next round and/or sets of parties being provided by the at least one of an a potential member, a potential new member, rushee, and all of the sorority recruitment coordinators.

38. The system of claim 38, wherein the processing devices processes information regarding the mutual preferences of both potential members and sororities.
